(19) United States
(12) Patent Application Publication
(10) Pub. No.: US 2019/0150530 A1
(43) Pub. Date: May 23, 2019

(54) UNWEIGHTING GARMENTS FOR SIMULTANEOUS USE WITH UNWEIGHTING AND FALL SAFETY SYSTEMS

(71) Applicants: Steven L. BASTA, Menlo Park, CA (US); Clifford T. JUE, Santa Cruz, CA (US); Gregory P. MARECEK, Palo Alto, CA (US); Ross JAFFE, Atherton, CA (US); Philip W. LONG, Castro Valley, CA (US); Babu S. RAHMAN, Fremont, CA (US); Amanda WILLIAMS, Oakland, CA (US)

(72) Inventors: Steven L. BASTA, Menlo Park, CA (US); Clifford T. JUE, Santa Cruz, CA (US); Gregory P. MARECEK, Palo Alto, CA (US); Ross JAFFE, Atherton, CA (US); Philip W. LONG, Castro Valley, CA (US); Babu S. RAHMAN, Fremont, CA (US); Amanda WILLIAMS, Oakland, CA (US)

(21) Appl. No.: 16/010,149

(22) Filed: Jun. 15, 2018

Related U.S. Application Data
(63) Continuation of application No. 14/852,401, filed on Sep. 11, 2015, now abandoned.
(60) Provisional application No. 62/134,521, filed on Mar. 17, 2015.
(60) Provisional application No. 62/049,307, filed on Sep. 11, 2014.
(60) Provisional application No. 62/049,149, filed on Sep. 11, 2014.

(51) Int. Cl. A41D 13/00; A41D 1/06

(52) U.S. Cl. CPC A41D 13/0007; A62B 35/0006; A41D 1/06

(57) ABSTRACT

An integrated unweighting garment includes one or more reinforcement straps to couple the garment to a fall safety system. An unweighting garment includes an article of clothing having two leg portions configured to fit around legs of a user, a buttocks portion configured to fit around the user's buttocks, and a waist portion configured to fit proximate to hips of the user. One or more force distribution loop sections or reinforcement straps provided are attached along both leg portions or the buttocks portion or other portion of the garment or shoulder strap. An unweighting garment may include one or more of a sensor, a compression system or overhead suspension system connection points.

### CROSS REFERENCE TO RELATED APPLICATION

This application is a continuation of U.S. patent application Ser. No. 14/852,401, filed Sep. 11, 2015, titled “UNWEIGHTING GARMENTS FOR SIMULTANEOUS USE WITH UNWEIGHTING AND FALL SAFETY SYSTEMS,” now U.S. Patent Application Publication No. 2016/0073704, which claims priority to U.S. Provisional Patent Application No. 62/134,521, filed Mar. 17, 2015, titled UNWEIGHTING GARMENTS FOR SIMULTANEOUS USE WITH UNWEIGHTING AND FALL SAFETY SYSTEMS;” U.S. Provisional Patent Application No. 62/049,307, filed Sep. 11, 2014 titled “UNWEIGHTED TRAINING SYSTEMS AND METHODS OF USING AND CALIBRATING SUCH SYSTEMS FOR MOBILITY IMPAIRED OR OBESE USERS;” and U.S. Provisional Patent Application No. 62/049,149, filed Sep. 11, 2014, titled “UNWEIGHTING GARMENTS,” each of which are herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

Described herein are various embodiments of reinforced garments for use in systems for unweighting or offsetting an individual's load or permitting exercise in combination with one or more fall safety devices also connected using the garment.

### BACKGROUND

Methods of counteracting gravitational forces on the human body have been devised for therapeutic applications as well as physical training. Rehabilitation from orthopedic injuries or neurological conditions often benefits from precision unweighting (i.e. partial weight bearing) therapy.

Differential Air Pressure (DAP) systems have been developed to use air pressure in, for example, a sealed chamber to simulate a low gravity effect and support a patient at his center of gravity without the inconvenience of water-based therapies. DAP systems generally utilize a chamber for applying differential air pressure to a portion of a user's body. In order to use these systems, an air-tight seal must be established with the user's body. This seal typically requires that a close-fitting garment be worn. Wearing this close-fitting garment over other garments worn by the user, in addition to the necessary presence of the pressurized air chamber surrounding the user, however, can cause discomfort and/or restriction of the natural arm swing as the user moves. Moreover, in some instances, an individual may have limited or low degree of mobility, which may hinder his ability to access the chamber and/or garment.

An alternative to DAP systems are the less expensive traditional methods of counteracting the effects of gravity by suspending a person using a body harness to reduce ground impact forces. Suspension systems can be inexpensive in that these systems can be used with a user's existing home gym or exercise equipment. However, currently available harness systems are often uncomfortable and result in direct vertical lifting that can distribute weight unnaturally and uncomfortably on the user's body. Harness systems often employ the use of bungee or tensioning cords and cables that need to be hooked or unhooked to harnesses worn by the users. The harnesses themselves are generally uncomfortable as pressure points develop where the lifting force pulls on the user's body. In some cases, prolonged use with these harness suspension systems can result in injuries that range from mild skin abrasion or contusions to musculoskeletal injury.

An additional alternative to DAP systems includes unweighting systems that mechanically unweight an amount of the user's weight similar in principle to the unweighting benefits of DAP systems. Mechanical unweighting systems also enable training methods for counteracting the effects of gravity by mechanically unweighting a user to reduce ground impact forces.

As such, a need exists for a garment design that can be used with inexpensive unweighting system such as suspension systems and/or DAP and/or mechanical unweighting systems that allow users to comfortably unload a portion of their weight. Additionally, a need exists for a garment design that can be used easily by those users desiring fall safety protection as well.

### SUMMARY OF THE DISCLOSURE

Embodiments described herein provide unweighting garments with force distribution portions to comfortably distribute a lifting or suspension force on a user's body. Moreover, embodiments described include access features and size adjusters allowing users to easily put on and take off the unweighting garments. Integral to these designs are one or more attachment points to be used in cooperation with a fall safety system or device.

In general, in one embodiment, an unweighting garment includes an article of clothing having two leg portions configured to fit around legs of a user and a waist portion configured to fit proximate to hips of the user. A pair of attachment mechanisms is in the waist portion. The pair of attachment mechanisms is configured to attach the article of clothing to a device for unloading a portion of the user's weight. A pair of force distribution sections is within or attached to the article of clothing. Each force distribution section extends from one of the attachment mechanisms and along one of the leg portions. The pair of force distribution sections is configured to distribute a force acting on the pair of attachment mechanisms to the legs of the user when the article of clothing is attached to the device and the portion of the user's weight is unloaded.

The unweighting garment may also be configured to extend over a portion of the abdomen or abdomen and torso of a user. Optionally, an adjusting mechanism may be provided to adjust the fit of various regions of the garment to the user.

In general, in one embodiment, a fall mitigation garment for use with a differential air pressure system, including an article of clothing having two leg portions configured to provide an airtight fit around legs of a user and a waist portion configured to fit proximate to hips of the user; a differential air pressure seal coupled to the waist of the garment and including an engagement element used to form a seal with a component of a differential air pressure system; a support strap attached to the article of clothing extending from the waist portion along and around the user leg portions and to form a pair of suspenders adapted to extend over the user's shoulders; and an overhead support system adapted to be coupled to the user via the suspenders.

This and other embodiments can include one or more of the following features. In one aspect, the garment can further include a fitting to couple the suspenders to the overhead support system. In another aspect, the fitting can be a D-ring. In a further aspect, the fitting can include a snap shackle. In an alternative aspect, the support strap can be a strip of nylon webbing. In yet another aspect, the support strap can be a strip of nylon webbing that can be stitched to the garment at a spacing wherein a loop of the support strap can be formed between each location where the support strap can be stitched to the garment. In still another aspect, the support strap can be a strip of nylon webbing that can be stitched to the garment at a spacing wherein a loop of the support strap can be formed at a pre-determined interval along a portion of the garment. In one aspect, a portion of the suspenders can be an elastic material further including a limited elastic material support strap attached to the suspenders to form one or more loops of the support strap. In another aspect, the garment can include a sacrificial stitch positioned to indicate when use of the garment should end. In a further aspect, the garment can further include a restraining strap attached to a portion of the suspenders to maintain the fitting in relation to the overhead support system connection point. In an alternative aspect, the garment can further include a portion of the garment extending over a portion of the user abdomen or torso. In yet another aspect, the garment can further include a reel tensioned adjustment device within a portion of the garment extending over a portion of the user abdomen or torso or in a portion of the garment adjacent a thigh or the buttock. In still another aspect, the garment can further include a pair of attachment mechanisms in the waist portion, the pair of attachment mechanisms can be configured to attach the garment to a device for unloading a portion of the user's weight. In one aspect, one single reinforcement member can be provided to be the reinforcement member within or attached to the article of clothing extending from one of the attachment points and along and around the user leg portions to another of the attachment points and the straps extending from the attachment points to extend over the user's shoulders with a fitting to couple the straps to the overhead device. In another aspect, the garment can further include a portion of the support strap around the leg portion and along an interior aspect of the thigh can have a length of the support strap that can be about the same length as the underlying garment material.

In general, in one embodiment, a fall mitigation garment, including an article of clothing having two leg portions configured to fit around legs of a user and a waist portion configured to fit proximate to hips of the user; a pair of attachment points in the waist portion, the pair of attachment points configured to attach the article of clothing to an overhead device for supporting a portion of the user's weight; a reinforcement member within or attached to the article of clothing extending from one of the attachment points and along and around the user leg portions to another of the attachment points; straps extending from the attachment points to extend over the user's shoulders with a fitting to couple the straps to the overhead device.

This and other embodiments can include one or more of the following features. In one aspect, the fitting can be a welded D-ring. In another aspect, the fitting can include a snap shackle. In a further aspect, the reinforcement member can be a strip of nylon webbing. In an alternative aspect, the reinforcement member can be a strip of nylon webbing that can be stitched to the garment at a spacing wherein a loop of the reinforcement material can be formed between each location where the reinforcement material can be stitched to the garment. In yet another aspect, the reinforcement member can be stitched to the garment at a spacing wherein a loop of the reinforcement material can be formed at a pre-determined interval along a portion of the garment. In still another aspect, the straps extending from the attachment points to extend over the user's shoulders can include an elastic material and a reinforcement material can be attached to the shoulder straps to form one or more loops of reinforcement material. In one aspect, the garment can include a sacrificial stitch positioned to indicate when use of the garment should end. In another aspect, the garment can further include a DAP seal coupled to the waist portion of the garment. In a further aspect, the garment can further include a portion of the garment extending over a portion of the user abdomen or torso. In an alternative aspect, the garment can further include a reel tensioned adjustment device within a portion of the garment extending over a portion of the user abdomen or torso or in a portion of the garment adjacent a thigh or the buttock. In yet another aspect, the garment can further include a pair of attachment mechanisms in the waist portion, the pair of attachment mechanisms can be configured to attach the garment to a device for unloading a portion of the user's weight. In still another aspect, one single reinforcement member can be provided to be the reinforcement member within or attached to the article of clothing extending from one of the attachment points and along and around the user leg portions to another of the attachment points and the straps extending from the attachment points to extend over the user's shoulders with a fitting to couple the straps to the overhead device. In one aspect, the garment can further include a portion of the reinforcement member around the leg portion and along an interior aspect of the thigh has a length of the reinforcement member that is about the same length as the underlying garment material.

Any of these embodiments can include one or more of the following features. The article of clothing can be a pair of shorts. The unweighting garment can further include a force distribution section coupled with the belt that can extend into a leg portion or buttocks portion. The force distribution section can be configured to further distribute the force from the attachment mechanisms to the legs or buttocks of the user. The force distribution section(s) can be configured to distribute force placed on the attachment mechanism to a thigh or hamstring of the user when the article of clothing is attached to the device. The force distribution section(s) may not overlap with a crotch area of the article of clothing. The force distribution sections(s) can be configured to distribute force placed on the attachment mechanism to the legs or buttocks of the user while the user is running or walking. The force distribution section(s) can at least partially encircle each of the leg portions of the article of clothing. At least one force distribution section can be a strap. There can be a plurality of straps. The plurality of straps can overlap one another such that the pair of attachment mechanisms can be coupled with each strap of the plurality of straps. The material can be a two-way stretch fabric that, when pulled in one direction, shrinks in another direction. The belt can include a plurality of rigid members. The rigid members can be articulatable with respect to one another. The force distribution section(s) can be configured to apply tensile force to the user along predetermined lines, sectors, or portions. The force distribution section(s) can be configured to apply circumferential force to the user. The force distribution section(s) can include nylon, neoprene, spandex, elastic fibers, an elastomeric polymer, cotton, or canvas. The force distribution section(s) can include a woven structure with biaxial or triaxial weaving. The material can include a garment having a fiber orientation, weave, or strand orientation that is different from the rest of the garment. The force distribution section(s) and the article of clothing can be sewn together or seamlessly joined. The force distribution section(s) can be under or overlaid on top of a layer of the article of clothing. The unweighting garment can further include at least one additional attachment element. The panels can be configured to tighten or loosen with a closing mechanism. The closing mechanism can include a lacing system, a cinching mechanism, hooks, laces, buckles, buttons, Velcro, or a zipper. The closing mechanism can be configured to extend axially down a lateral side of the user's leg. The pair of attachment element can be each attached to the article of clothing through a panel. The unweighting garment can further include a rigid member configured to further distribute the force. The pair of attachment mechanisms can include hooks, clips, lops, or Velcro. A strap can be configured to extend substantially axially down a lateral side of the user's leg. A strap can be configured to extend across a user's thigh. A strap can be configured to extend across a portion of the user's buttocks. A crotch area of the article of clothing can include four-way stretch fabric.

In still further alternative embodiments, any of the above unweighting garments may be modified to provide one or more of a sensor to measuring a physiological signal of a user wearing the unweighting garment. In still further embodiments of any of the above, there is also provided unweighting garments adapted and configured to measure physiologic signals such as EKG, EMG, SpO2 and pulse during active exercise or therapy. In some embodiments, there is provided an unweighting garment embodiment having one or more motion sensing or motion capture sensors. In one aspect, there is provided an unweighting garment including an inertial measurement unit. In still other unweighting garment embodiments, there is provided on an unweighting garment one or more accelerometers, gyroscopes or other sensors for detecting or measuring user movements. In another aspect, the placement or selection of a particular sensor or combination of sensors is selected and positioned on the unweighting garment to provide user specific data to assess one or more aspects of the user's gait. It is to be appreciated that the one or more sensors or sensor integration packages—depending upon the number of sensors or desired physiological signal or attribute being measured—are positioned within those locations available for sensor placement given the other unweighting garments other design requirements mentioned herein.

In still further embodiments, any of the above unweighting garments may be adapted and configured with one or more cable guide or routing arrangement that includes a tightening system or device adapted and configured to adjust the unweighting garment to accommodate users from User Categories I, II, III or IV including unweighting garments having one or more connections for use with an overhead suspension or patient assistance system.

In yet another embodiment, any above described unweighting garment can further include one or more attachment points adapted and configured for releasable attachment to one or more load transfer straps of a fall safety system. In a further embodiment, any above described unweighting garment can further include a DAP seal and wherein the one or more attachment points can be airtight attachment points for use with the DAP seal. In another embodiment, any above described unweighting garment can further include an overhead transport trolley attached to the one or more load transfer straps. In an further aspect, an unweighting garment can further include an overhead transport trolley and a load spreader wherein the transport trolley can be coupled to the load spreader and the one or more load transfer straps can be coupled to the load spreader. In an alternative embodiment, an unweighting garment can further include a height adjustment control device adapted and configured to adjust the length of one or more straps or connectors based on the user being in a sitting position or a standing position.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is a pair of unweighting shorts according to some embodiments.

FIGS. 2A and 2B illustrates the fiber structure of the force distribution section and main body of an unweighting garment.

FIG. 3 is a pair of unweighting shorts according to other embodiments.

FIG. 4 is a pair of unweighting shorts according to other embodiments.

FIG. 5 is a pair of unweighting shorts according to other embodiments.

FIG. 6 shows forces placed on a user during unweighting.

FIGS. 7A and 7B shows a pair of unweighting shorts with two attachment elements.

FIGS. 8A and 8B shows a pair of unweighting shorts with six attachment elements.

FIG. 9 illustrates a cross-section of the shorts in FIGS. 8A and 8B.

FIG. 10 illustrates a pair of unweighting shorts and force distribution by the shorts during unweighting.

FIG. 11 illustrates a user unweighted while running in the unweighted shorts of FIG. 10.

FIG. 12 illustrates a pair of size adjustable shorts.

FIG. 13 illustrates an alternative embodiment of size adjustable shorts.

FIG. 14 illustrates an alternative embodiment of size adjustable shorts.

FIG. 15 shows a pair of shorts with a force distribution section on the side of a leg member.

FIG. 16 shows a pair of shorts with a force distribution section on each leg member.

FIG. 17 shows the stretch directions for material that may be used for the force distribution section.

FIG. 18 shows a pair of shorts with two force distribution section separated by a portion of the main body.

FIGS. 19A and 19B shows a pair of shorts with and without force distribution sections.

FIGS. 20A-20C illustrates the stretched state of a force distribution section.

FIG. 21 shows a plurality of attachment members on a pair of shorts.

FIG. 22 illustrates a pair of shorts including a belt.

FIG. 22A shows an exemplary belt with articulating members.

FIG. 23 shows a pair of unweighting pants according to some embodiments.

FIG. 24 shows an attachment member having a roller.

FIGS. 25A and 25B shows cross-section of a roller pulley.

FIG. 26 shows a pair of unweighting pants according to some embodiments.

FIG. 27 shows a front view of the pants in FIG. 26.

FIG. 28 shows a rear view of the pants in FIG. 26.

FIG. 29 shows the force distribution panels of the pants in FIG. 26.

FIG. 30 shows force distribution along force distribution panels.

FIG. 31 shows a rear view of a garment including support straps configured to sit under or around the user's buttocks.

FIG. 32 shows a rear view of another garment including support straps configured to sit under or around the user's buttocks.

FIGS. 33A-33C show a garment including fabrics of different load characteristics. FIG. 33A is a front view. FIG. 33B is a side view. FIG. 33C is a back view.

FIGS. 34A-34C show another garment including fabrics or panels of different load characteristics. FIG. 34A is a front view. FIG. 34B is a side view. FIG. 34C is a back view.

FIG. 35 illustrates a perspective view of an unweighting garment adapted and configured for use with a DAP system.

FIG. 36 illustrates a perspective view of an unweighting garment adapted and configured for an overhead suspension, a fall support or other type of user assistance system. The garment in FIG. 36 may be further modified to have more or fewer connection points than the four illustrated. Additionally or alternatively, the unweighing garment of FIG. 36 may be adapted and configured for coupling to a DAP system or a mechanical unweighting system.

FIG. 37 is a perspective view of an unweighting garment adapted and configured for connection to a mechanical unweighting system.

FIGS. 38A and 38B are front and side views, respectively, of a variety of unweighting garment features that provide a custom fit to the user via a set of strategically located tightening mechanisms may be modified in many different ways to accommodate unweighting garment designs for users in User Categories I, II and III.

FIGS. 39A and 39B are front and side views, respectively, of a variety of unweighting garment features that may be modified in many different ways to accommodate unweighting garment designs for users in User Category IV.

FIGS. 40 and 41 illustrate perspective views of garments adapted for use with an unweighting system and a fall safety system.

FIG. 42 is a front view of a DAP short and seal with an embodiment of a lift assist support system attached

FIGS. 43A and 43B are front and rear views respectively of the DAP shorts of FIG. 42 showing the locations and path of the webbing supports.

FIG. 44A is a side, schematic view of an exemplary length of elastic garment body material with an inelastic or low elastic strap material attached to the body material at discrete points.

FIG. 44B is an isometric view of an embodiment of the garment with webbing as described in FIG. 44A.

FIGS. 44C, 44D, and 44E provide various force v. elongation curves.

FIGS. 45A and 45B are front and side views respectively of a DAP shorts and seal showing a path of the straps on the garment and in relation to the DAP seal. The DAP seal is removed from this view for clarity.

FIG. 46A is an exemplary view of the support webbing for the shoulders and shorts support attached using a box stitch that passes through the shoulder support webbing, the garment material, and the shorts webbing.

FIG. 46B is an exemplary box stitch as used in FIG. 46A.

FIG. 47 is a rear view of shorts with the reinforcing webbing showing the location of box stitches used to secure the webbing to the shorts elastic material.

FIG. 48A shows a D-ring positioned on a non-reinforced portion of a shoulder strap held in position using a retainer strip.

FIG. 48B is a side view of a D ring as described and illustrated in FIG. 48A in position on the shoulder strap.

FIG. 48C shows a D-ring positioned on a reinforced portion of a shoulder strap held in position using a retainer strip.

FIGS. 49A, 49B and 49C illustrate, respectively, front, rear and side views of a shorts having a reinforcing straps attached to the garment and including a shoulder strap.

FIG. 50A is a perspective view of a running support short with a DAP seal and indication of hip/waist style support points.

FIG. 50B is a perspective view of a running support short with a DAP seal hip support points.

FIG. 50C is a perspective view of a pair of shorts with a DAP seal and additional reinforcement for providing fall safety capabilities.

FIG. 50D is a perspective view of a pair of running shorts with fall safety reinforcements as illustrated in FIG. 50C and including an embodiment of a shoulder suspension system.

FIG. 51 is a perspective view of an exemplary test fixture utilized to test the strength of garments having reinforcement webbing straps.

### DETAILED DESCRIPTION

Described herein are garments, such as shorts, configured to distribute a load during unweighting of a user. The garments can be configured to include a waist portion that sits proximate to a user's hips and leg portions configured to cover or surround a user's upper legs. The garment can include a pair of attachment mechanisms configured to attach to an unweighting device and one or more force distribution configured to distribute force to the user's thighs when a force is placed on the attachment mechanisms.

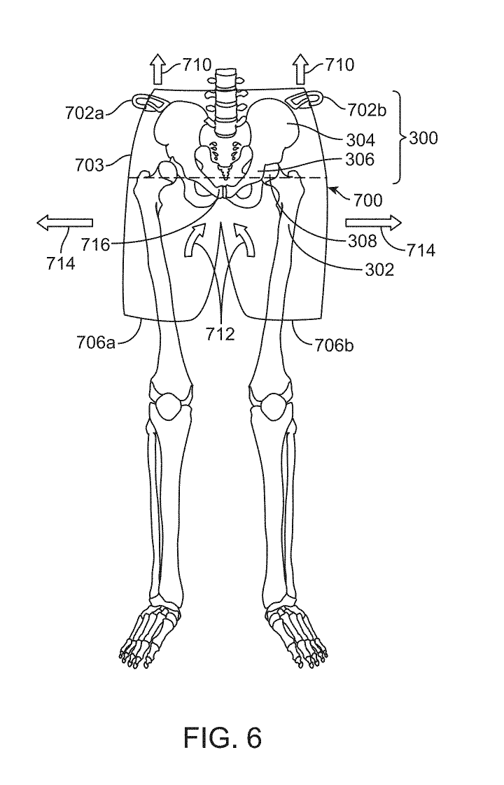

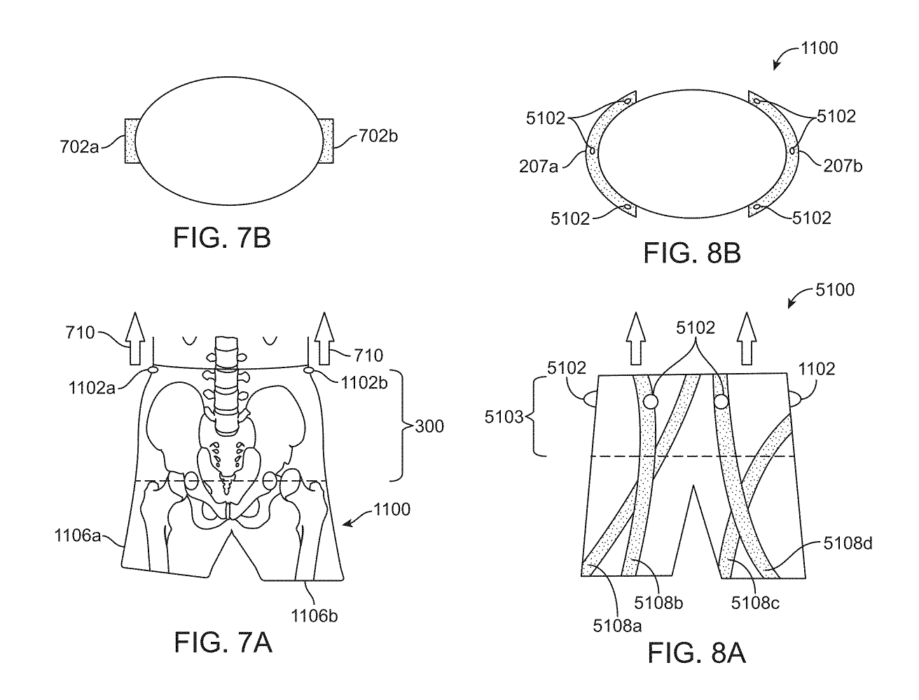

FIGS. 6 and 7A show the placement of components of the garments described herein relative to a user's body. Referring to FIG. 6, an exemplary garment 700 shaped as shorts can have a waist section 703 configured to surround, overlap, or sit proximate to a user's hips 300. Thus, the waist section 703 can surround the space bounded by the iliac crest 304, the ilium 306, and the acetabelum 308. A pair of attachment mechanisms 702a,b can be connected to the shorts within the waist portion 703 (such as near the top of the waist sections at or just above the iliac crest 304). The attachment mechanisms 702a,b can be configured to attach to an unweighting system, such as those described in U.S. patent application Ser. No. 11/236,952, filed Sep. 28, 2005, titled “SYSTEM, METHOD AND APPARATUS FOR APPLYING AIR PRESSURE ON A PORTION Of THE BODY OF AN INDIVIDUAL,” now U.S. Pat. No. 7,591,795; U.S. patent application Ser. No. 12/761,316, filed Apr. 15, 2010, titled “SYSTEMS, METHODS AND APPARATUS FOR DIFFERENTIAL AIR PRESSURE DEVICES,” now U.S. Patent Application Publication No. US 2011-0098615-A1; U.S. patent application Ser. No. 12/778,747, filed May 12, 2010, titled “DIFFERENTIAL AIR PRESSURE SYSTEMS,” now U.S. Pat. No. 8,464,716; International Patent Application No. PCT/US2014/020741, filed Mar. 5, 2014, titled “CURVED RESILIENT MEMBER UNWEIGHTING SYSTEMS;” now Publication No. WO 2014/138228; International Patent Application No. PCT/US2014/020863, filed Mar. 5, 2014, titled “MONOCOLUMN UNWEIGHTING SYSTEMS,” now Publication No. WO 2014/138281; International Patent Application No. PCT/US2014/028694, filed Mar. 14, 2014, titled “CANTILEVERED UNWEIGHTING SYSTEMS,” now Publication No. WO 2014/153016; International Patent Application No. PCT/US2014/029002, filed Mar. 14, 2014, titled “CURVED RESILIENT MEMBER UNWEIGHTING SYSTEM,” now Publication No. WO 2014/153088; U.S. Provisional Patent Application No. 62/013,999, filed Jun. 18, 2014, titled “DIFFERENTIAL AIR PRESSURE TREADMILL SYSTEM;” and U.S. Provisional Patent Application No. 62/024,916, filed Jul. 15, 2014, titled “PRESSURE CHAMBER AND LIFT FOR DIFFERENTIAL AIR PRESSURE SYSTEM,” the entirety of each of the above referenced patents and patent applications are incorporated by reference herein. Further, leg members 106a,b can be configured to surround at least a portion of the user's femur 302.

As described further below, the garments described herein (such as garment 700) can further include force distribution sections (not shown in FIG. 6) configured to distribute force applied to the attachment mechanisms 702a,b during unweighting. That is, when the user is attached to an unweighting system via the attachment mechanisms 702a,b, various upward and/or lateral force (shown by force arrow 710) is applied to the attachment elements 702a,b, thereby pulling the shorts 700 (and the user) upwardly and/or laterally. If no force distribution sections are present, then the force can be uncomfortably heavily exerted on the user's crotch or groin area 716, as shown by the force arrow 712. Further, without force distribution sections, the upward or lateral lift force may cause torque near the hips 300 or the femur 302 that causes the user's legs to move outward (as shown by force arrow 714), causing instability. The force distribution sections described herein can thus counteract these undesirable rotations or pressure points.

A similar garment 1100 is shown in FIGS. 7A and 7B. The garment 1100 includes a waist portion 1103 that rests just at or above the hips 300 of the user and two leg members 1106a,b. Two attachment elements 1102a,b sit in the waist portion 103, such as just above the hips 300 of the user. The garments described herein can further include force distribution sections (not shown in FIG. 7A) to distribute force applied to the attachment mechanisms 1102a,b. Thus, when an upward or later force (shown by the arrow 710) is applied to the attachment elements 702a,b, the force distribution sections can distribute or transfer the load, thereby avoiding unwanted pressure points or rotations.

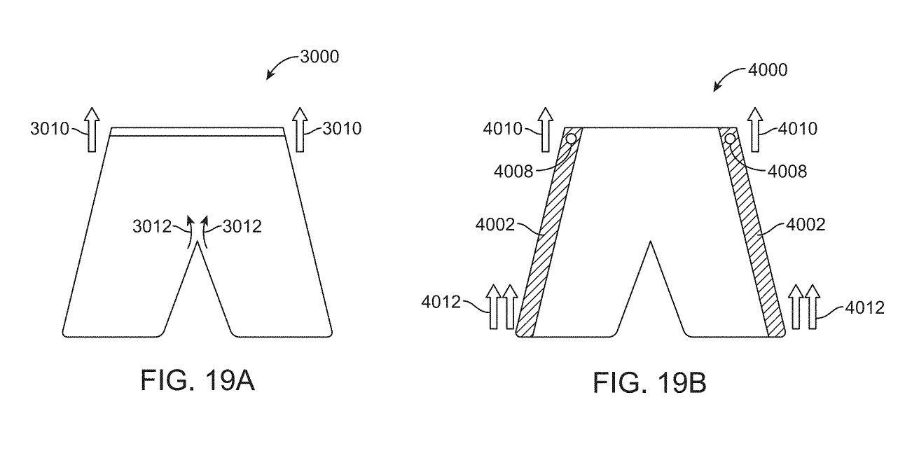

The force distribution sections can allow unweighting force (e.g. lifting force) and/or the unloaded weight of the user to be more evenly distributed. FIG. 19A shows the distribution of unweighting forces in a garment 3000 without a force distribution section where the unweighting lifting force (shown by arrow 3010) is applied near the user's hips. As the lifting force lifts against the shorts, the shorts will naturally slide upward on the user's legs. This can result in a substantial amount of pressure and force being focused on the user's crotch area (as shown by arrows 3012) to carry the unloaded user weight. This is uncomfortable and can cause injury. In contrast, FIG. 19B shows a garment 4000 (pair of shorts) having force distribution sections 4008a,b on the sides of each leg portion 4006a,b. When an unweighting force such as a lifting force (shown by arrows 4010) is applied to attachment elements 4002a,b near the user's hips, the unweighting force is distributed through the force distribution sections 4008a,b and down the user's legs (as shown by arrows 4012). Moreover, the user experiences unloading force from the hips and from the lower thigh area rather than substantially in the groin area. Advantageously, distributing the unweighting force prevents the garment from “riding up” on the user and provides overall comfort during unweighting.

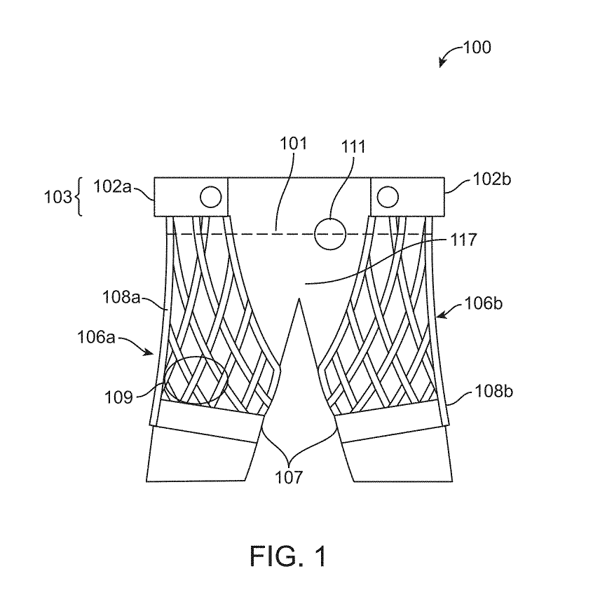

Thus, referring to FIG. 1, a garment 100 can include a main body 101 and force distribution sections 108a,b. The main body 101 can be shaped as shorts with a waist section 103 and two leg members 106a,b. The main body 101 can include the portions of the garment in contact or surrounding the user's body part(s). The main body 101 may be distinguished from the force distribution section in type of fabric or material, area of the user's body covered, and/or mechanical or physical properties, such as the ability to distribute unweighting force or the user's load. The main body 101 can be formed from a stretchable, breathable material. Suitable materials include natural fibers such as cotton or canvas and synthetic fibers such as nylon, neoprene, spandex, elastic fibers, elastomeric polymers (e.g. polyethylene), Lycra, or any blends of materials.

As described in the embodiments above, the waist section 103 may also include one or more attachment elements 102a,b for attaching the garment to an unweighting system. The attachment elements 102a,b can include any mechanical means or mechanism for attaching or coupling the garment to an unweighting system, such as hooks, clips, loops, or Velcro. The attachment elements 102a,b may be attached to both the main body 101 and/or the force distribution section 108a,b. For example, in the case where a force distribution section 108a,b is placed onto of textiles or fabrics of the main body 101, the attachment element 102a,b may be fixed or secured to both fabrics.

The leg members 106a,b can extend from the waist section 103. In some embodiments, leg cuffs 107 can be placed at an end of the leg members 106a,b. In some embodiments, the leg members 106a,b have a length sufficient to cover and surround the user's thighs. In further embodiments, the leg members 106a,b may reach from the user's hips to partway down their thighs. In other embodiments, the leg members 106a,b may reach from above the user's waist and down to below the knees. In still other embodiments, the leg members may extend to the user's ankles or above the user's feet.

The force distribution sections 108a,b can extend from the attachment mechanisms 102a,b into the leg members 106a,b. The force distribution sections 108a,bcan include straps made of webbing (e.g., of nylon or polyester), fabrics of different characteristics than the rest of the main body, and/or panels that are configured to cinch together.

In some embodiments, the force distribution sections 108a,bmay redistribute or direct a lifting force applied to the user (i.e., through the attachment mechanisms 102a,b) into tensile force applied along predetermined lines, sectors or portions. In other embodiments, the force distribution sections 108a,b can be used in the garment 100 to convert a portion of a lifting force applied to the garment into a partial, complete or overlapping circumferential compression force. The tensile or compressive forces provided by the one or more force distribution sections 108a,b may assist in keeping the garment 100 in a desired position on the user's body, redistribute forces that would otherwise cause pain or unwanted rotation, and/or prevent the garment 100 from riding up the user's body during use. In some embodiments, a force distribution section 108a,b may include aspects that provide both tensile (lift) force distribution and compressive force distribution.

Suitable materials suited for use with the force distribution section 108a,binclude, for example, natural fibers such as cotton or canvas and synthetic fibers such as nylon, neoprene, spandex, elastic fibers, elastomeric polymers (e.g. polyethylene), Lycra, or any blends of materials. In some embodiments, the fabrics used in a force distribution section 108a,b may have a weight of about 8 ounces/square yard, 12 ounces/square yard, or 10.9 ounces/square yard. The force distribution section may, additionally or alternatively, also include either a nonwoven or woven structure. In some embodiments, the force distribution sections 108a,b may include or be lined with a stretchable, breathable material.

In some cases, the force distribution sections 108a,b employ a woven structure with multi-directional weaving. For example, the woven structure may be a biaxial or triaxial braiding or weaving of the fabric fibers. In some embodiments, the force distribution section 1108a,b is made of a mesh or netted weave that is woven with large gaps or holes. In one aspect, the fabric is cut on a bias and incorporated into the garment so that the lifting force causes the fabric section to contract in a predetermined way (i.e., determined by the fabric cut, fiber orientation, weave, strand orientation and the like alone or in combination). In one example, the lifting force acts on the material of the force distribution section 108a,b that responds by tightening the grip of the garment on a portion of the user's body that is within the garment. In other embodiments, the force distribution sections 108a,b are made from a fabric 108a,b that has variable movement in different directions.

The main body 101 and the force distribution sections 108a,b can be attached together in any suitable manner. In some embodiments, the main body 101 and the force distribution sections 108a,b are integrated together, such as by being sewn together or seamlessly joined (or threaded) together, on a fiber level. In some embodiments, the force distribution section can be under or overlaid on the main body 101. For example, a woven or mesh fabric may be placed over the fabric of the main body. In other embodiments, the force distribution sections 108a,b are enclosed within another material that forms the garment 100. For example, shorts or pants suited for use as an unweighting garment may have an outer shell and an inner liner. For both ease of use, comfort and appearance, the force distribution section 108a,b may be disposed between the outer shell and inner liner and attached to one or both of the liner/shell.

Further, the main body 101 and the force distribution sections 108a,b may be made from the same or different materials. Further, in some embodiments, the structure and materials within either the main body 101 or the force distribution sections 108a,bmay vary within the respective sections. For example, the weave of the force distribution sections 108a,bmay be a biaxial weave in one section and a triaxial weave in another section. Similarly, the main body may 101 include a moisture wicking and friction reducing material at, for example, the crotch area, to keep the user comfortable during movement.

The description of the various components and aspects of FIGS. 1, 6, 7, and 19B above can be applicable to any garment described herein. Specific examples are described below. Similar reference numerals have been used to indicate like elements. However, it is to be understand that components described with respect to one or more specific examples are interchangeable with components described with respect to any other specific examples.

Referring to the more specific features of FIG. 1, the main body 101 spans an area around the user's groin to a portion of the waist section 103 inward from the user's hips. The two force distribution sections 108a,b are attached to the main body 101 so as to form the rest of the garment 100 (i.e., to form shorts). Each force distribution section 108a-b extends from an area around the user's hip at the attachment mechanisms 102a,b to the end of the leg members 106a,b near the leg cuff 107. Further, in the specific embodiment shown in FIG. 1, the force distribution sections 108a,bare each narrower at the top near the user's hip than at the bottom near the user's leg or thigh so as to avoid a crotch area 117 of the shorts (thereby avoiding the placement of force on the user's groin area). Further, the force distribution sections 108a,bcan together at least partially surround the user's hips while each force distributions section 108a,bcan at least partially surround a portion of the user's legs. As shown in FIG. 1, the force distribution sections 108a-b substantially surround the area of the user's leg above the leg cuff 107 and below the crotch area 117 (i.e. extend circumferentially around each leg member 106a,b), but do not completely surround the user's waist. Although FIG. 1 shows the front of the garment 100 having the force distribution sections 108a-b, it can be appreciated that the back of the garment 100 has the same or similar architecture. In other embodiments, the back of the garment 100 may have a different force distribution section, for example, the entire back of the garment 100 may provide force distribution. This may be advantageous where the front of the garment 100 near the crotch area 117 must be relatively free of force distribution to prevent unwanted tensioning, tightening, or compression of the crotch area. In use, when a lifting force is applied to the attachment elements 102a,b, of garment 100, the force distribution sections 108a,bcan transfer force from the side of the user's hips along and/or around the legs (such as the thighs) of the user.

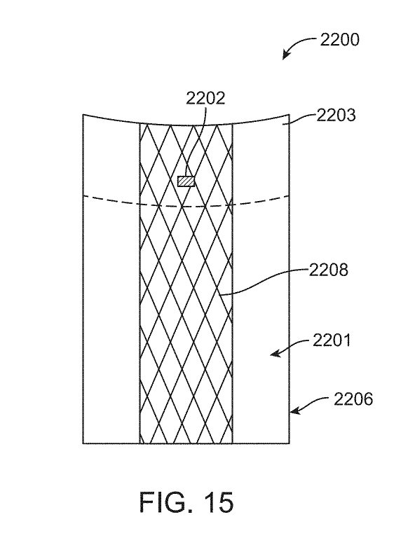

Another example of an unweighting garment 2200 with a force distribution section 2208 is shown in FIG. 15. FIG. 15 shows a garment 2200 (formed as a pair of shorts) with a waist section 2203 and a force distribution section 2208. In this embodiment, the force distribution section extends through an attachment mechanism 2202 in the waist portion 2203 and linearly down a side of a leg member 2206. The force distribution section 2208 can be, for example, placed on top of the main body 2201 (i.e., as an additional piece of fabric above the fabric of the main body). Alternatively, the leg member may be made such that the force distribution section 2208 is attached between two portions of the main body 2201. The force distribution section 2208 can be, for example, a mesh or woven fabric. In use, a lifting force applied to the attachment mechanism 2202 can be transferred through the force distribution section 2208 from the outside of the user's hips down the side of the user's leg.

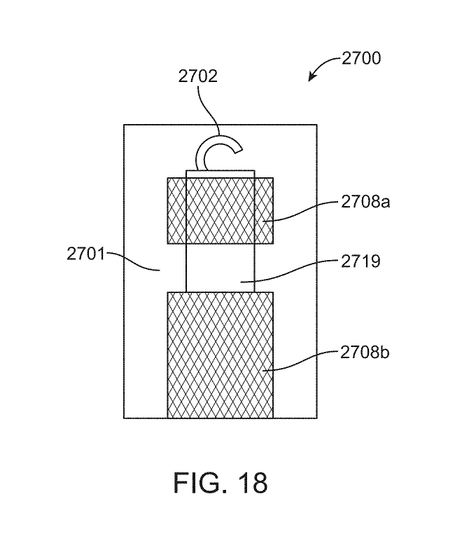

Another exemplary unweighting garment 2700 with force distribution sections 2708a,b is shown in FIG. 18. FIG. 18 shows the side of a leg member for a pair of shorts 2700 where two force distribution sections 2708a,b are vertically (when worn by the user standing upright) separated by a portion of the main body. Both the first and second force distribution portions 2708a,b can be connected to an attachment element 2702 (here shown as a hook) through a strip of fabric or panel 2719 within or over the main body 2701. The panel 2719, in combination with the force distribution sections 2708a,b, can transfer a lifting force applied to the attachment element 2702 from the outside of the hips of the user down the side of the user's leg.

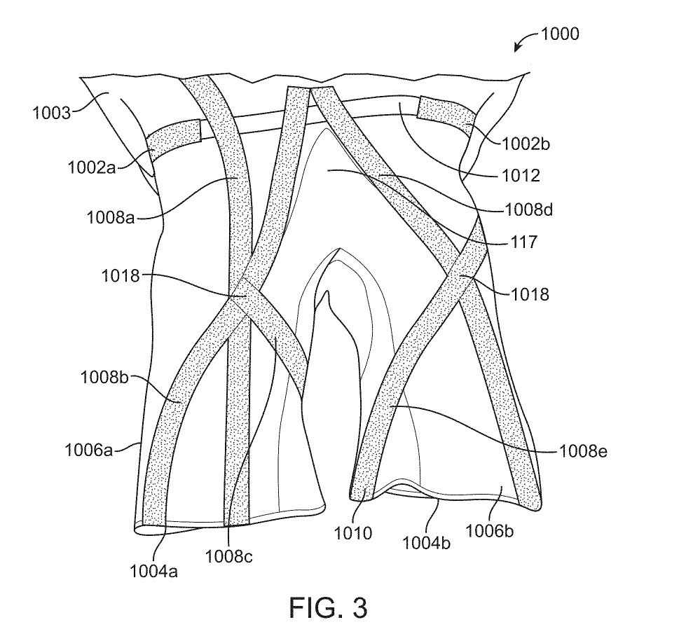

Another exemplary unweighting garment 1000 with force distributions sections 1008a-e is shown in FIG. 3. The garment 1000 includes a waist section 1003 with attachment elements 1002 therein as well as leg members 1006a,b extending from the waist section 1003. Each of the force distribution sections 108a-e is a fabric panel or strap that extends at least part of the length or width of the garment 1000. The garment can further include a belt strip 1012 in the waist portion 1003 and configured to extend circumferentially around the garment 1000, such as through each of the attachment elements 1002a,b. As shown in FIG. 3, all of the force distribution sections 108a-e can either attach to or extend through the belt strip 1012 or overlap with one another, thereby allowing force to transfer from the attachment elements 1002a,b to the belt strip 1012, and ultimately to the force distribution sections 1008a-e. Further, the force distribution sections 108a-e can be configured so as to avoid the crotch area 117 of the garment, thereby avoiding the placement of forces on the user's groin. It is can appreciated that any number of force distribution sections 108a-e may be used on the garment 1000 as is suitable for distributing the force around the user's body. Additionally, it can be appreciated that the back and front of the garment 1000 may have the same or different architecture and structure.

Referring still to FIG. 3, in some embodiments, the strips forming the force distribution sections 1008a-e extend from the waist portion 1003 to the end 1004a-b of the leg member 1006a-b. The force distribution sections 1008a,b may be coupled to the main body 1001 or to one another in the waist section 1003 (such as to the belt 1012) or anywhere above the crotch section 117 of the garment 1000. In some embodiments, the force distribution sections 1008a,b may not extend the entire length of the garment 1000. For example, force distribution section 1008c extends circumferentially from a connecting (strap overlap) point 1018 on the front of the garment 1000 around a portion of the leg member 1006a. As shown, the force distribution sections 1008a,b,c overlap at a connection point 1008a while the force distribution sections 1018e,f overlap at a connection point 1018b. The connection point(s) 1018 may be anywhere on the garment 1000, other examples of which are described further below.

In some embodiments, the force distribution sections 108a-e of the garment 1000 of FIG. 3 are attached onto the main body 1001 of the garment 1000. For example, the force distribution sections 108a-e are overlaid on the main body 1001. In other embodiments, the force distribution sections 108a-e are distinct components joined or attached to the main body 1001, such as by sewing or stitching the panels between unconnected portions of the main body 1001. In further embodiments, the force distribution sections 108a-e are seamlessly joined to the main body 1001 by altering the structure of the garment 1000 on a fiber level. The force distribution sections 108a-e may be a material different from the main body 1001, such as a woven material joined to the nonwoven web of the main body 1001.

Further, in some embodiments, the force distribution sections 108a-e of the garment 1000 of FIG. 3 can extend along an axis or parallel to an axis (such as the longitudinal axis) of the garment 1000. In other embodiments, the force distribution sections 108a-e extend in a slanted or oblique direction relative to an axis of the garment 1000. For example, force distribution section 1008a can extend substantially parallel one the longitudinal axis of the garment 1000 while the rest of the force distribution sections 1008b-e can be positioned at an angle relative to the longitudinal axis of the garment 1000.

In use, a lifting force applied to the attachment elements 1002a,b can be transferred through the belt strip 1012 to each of the force distribution sections 1008a,b either directly or through an overlapping force distribution section 1008a,b. This transferring of force can move the force away from the outside of the user's hips and spread it over and around the user's legs, such as the user's thighs.

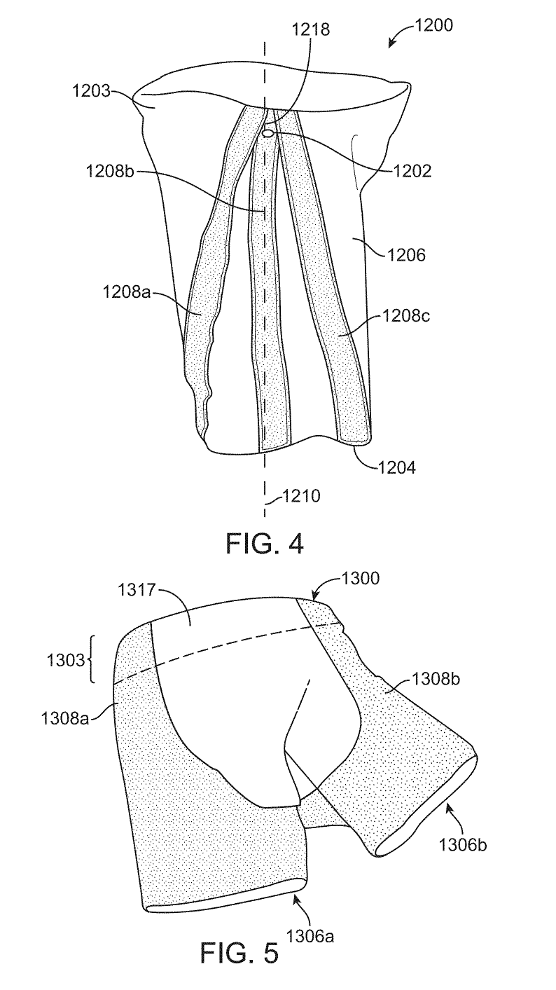

Another exemplary garment 1200 with force distribution sections 1208a,b,c is shown in FIG. 4. Similar to the garment 1000 of FIG. 3, the force distribution sections 1208a-c of garment 1200 are configured as overlapping straps or panels. The three force distribution sections 1218a,b,c of garment 1200 all extend from a common connection 1218 on the waist 1203 and then splay outwards to different locations at the end 1204 of the leg member 1206. Force distribution section 1208b extends the length of the leg member 1206 along a longitudinal axis 1210. Force distribution sections 1208a and 1208c extend obliquely relative to the longitudinal axis 1210. The garment 1200 further includes an attachment element 1202 at or near the connection 1218. In use, force applied to the attachment element 1202 can be transferred down all of the strips 1208a,b,c, thereby transferring the force from outside of the user's hips down the side of the user's leg.

Another exemplary garment 1300 with force distribution sections 1308a,b is shown in FIG. 5. The force distribution sections 1308a,b extend through the waist section 1303 and through a majority of the leg members 1306a,b (including front and back) while avoiding the crotch area 1317. In some embodiments, the force distribution sections 1308a,b can merge in some sections. The force distribution sections 1308a,b wrap around the user's leg area and cover at least a portion of the user's backside. In some embodiments, the force distribution sections 1308a,b may constitute the entire backside of the garment 1300. Any shape may be used for the force distribution sections 1308a,b. Shapes include triangles, trapezoids, curved shapes such as catenary or parabolic curves. In use, force applied to attachment elements on the shorts can be transferred throughout the shorts to the hips and legs of the user while avoiding the user's groin area.

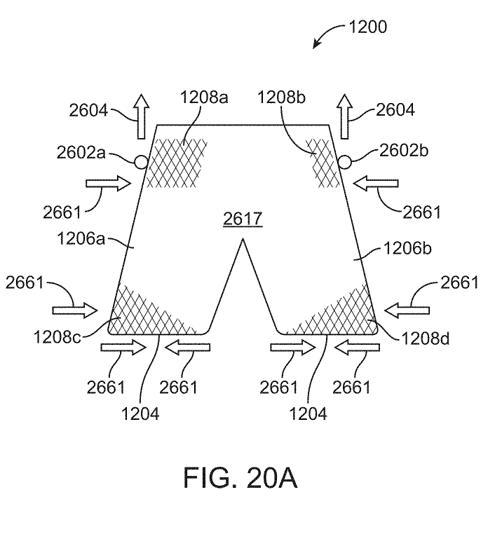

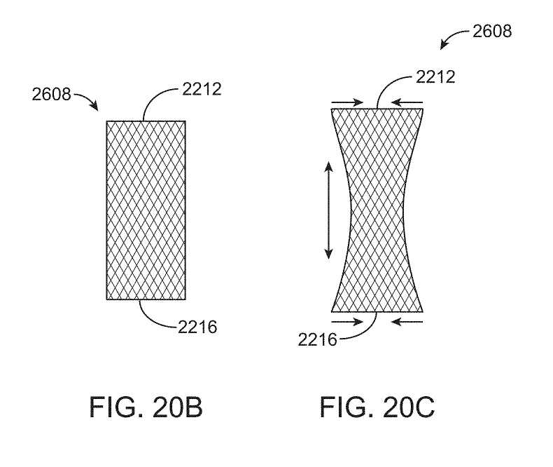

Another exemplary garment 2600 with force distribution sections 2608a,b,c,d is shown in FIG. 20A. The force distribution sections 2608a-d can include patches of material at or near the hips (sections 2608a,b) and near the bottom 2604 of the leg members 2606a,b (sections 2608c,d). Further, the force distribution sections 2608a,b can be overlapping with or connected to (such as through a strap or connector) the attachment elements 2602a,b. As shown in FIG. 20A, the sections 2608c,d at the bottom can be tapered such that more material is included towards the outside of the leg members 2606a,b than towards the crotch area 2617. Further, the force distribution sections 2608a-d can be formed of a mesh material that, when pulled vertically, stretches axially and compresses vertically. Thus, in use, when a lifting force (shown by arrows 2604) is applied to the attachment mechanisms 2602a,b, the force distribution sections 2608a-d (coupled with the attachment mechanisms 2602a,b) can stretch vertically, thus placing a compressive force (shown by arrows 2661) around an adjacent body part. FIG. 20B shows a force distribution section 2608 in an unstretched neutral state. Further, FIG. 20C shows the force distribution section 2608 in a stretched state. As shown, the length is stretched and elongated while the thickness is shortened and pulled inward. For example, where the force distribution section 2608 is next to a user's lower thigh, the force distribution section 2608 would tighten around the user's lower thigh. In some embodiments, the force distribution sections may include a plurality of compressing and tightening sections as well as a plurality of non-compressing sections. For example, the material and placement of the force distribution section may be selected to prevent substantial compression on the upper thigh while at the same time supporting compression near the area above the user's knee. In some embodiments, the force distribution section may provide a compressive force at opposing ends while stretched. FIG. 20C shows opposing ends 2212 and 2216 with compressive forces while the force distribution section 2218 is stretched.

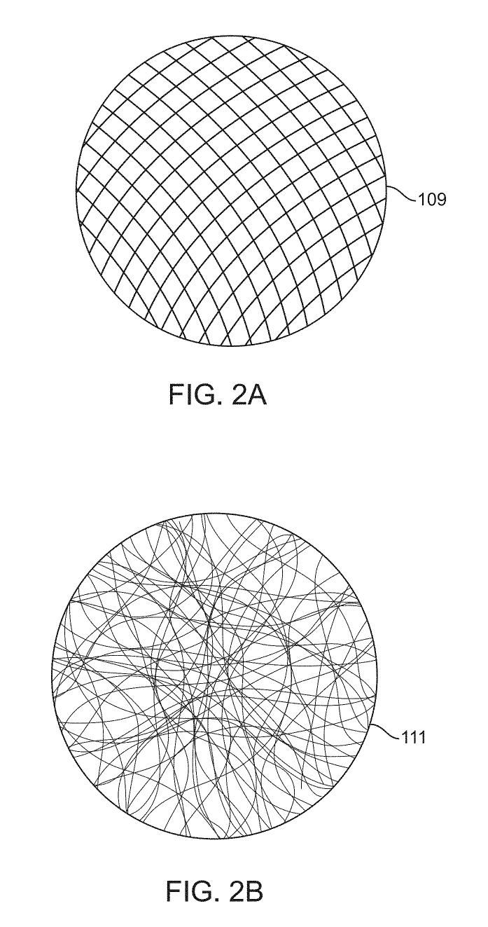

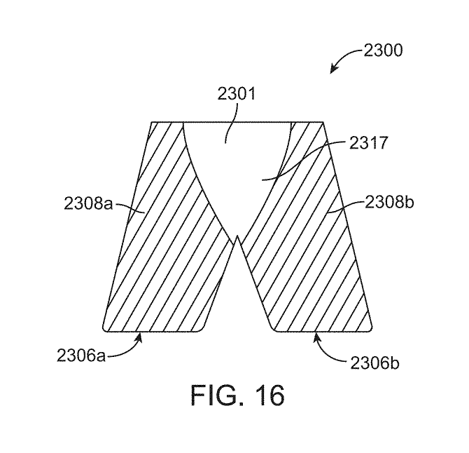

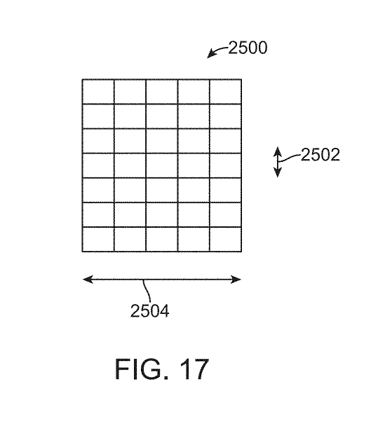

Another exemplary unweighting garment 2300 with force distribution sections 2308a,b is shown in FIG. 16. FIG. 16 shows force distribution sections 2308a,b forming substantially all of the leg members 2306a,b of a pair of shorts 2300. The main body 2301 (including the crotch area 2317) is joined to the force distribution sections 2308a,b to form the garment 2300. In one embodiment, the material for the main body 2301 and the force distribution sections 2308a,b can be the same with only the fiber structure differing. For example, the main body 2301 may have a nonwoven web fiber structure 111 (FIG. 2B) whereas the force distribution portion comprises a biaxial fiber weave 109 (FIG. 2A). Further, the main body 2301 and the force distribution sections 2308a,b may differ in the elasticity of the materials used for each. For example, the force distribution sections 2308a,b use a fabric that allows greater horizontal stretching compared to vertical stretching. This may be different from the fabric used for the main body 2301. FIG. 17 shows a fabric 2500 that exhibits greater elasticity in the horizontal direction 2504 compared with the vertical direction 2502. In some cases, the fabric is woven to minimize movement in one axis of direction. In other embodiments, alternatively, the fabric may have similar elasticity in multiple directions. In use, lifting force applied to the garment 2300 can be transferred throughout the user's hips and legs while avoiding the user's groin area.

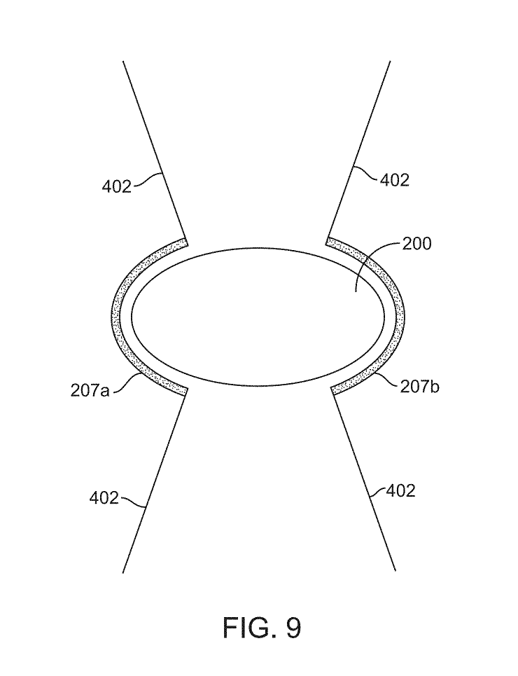

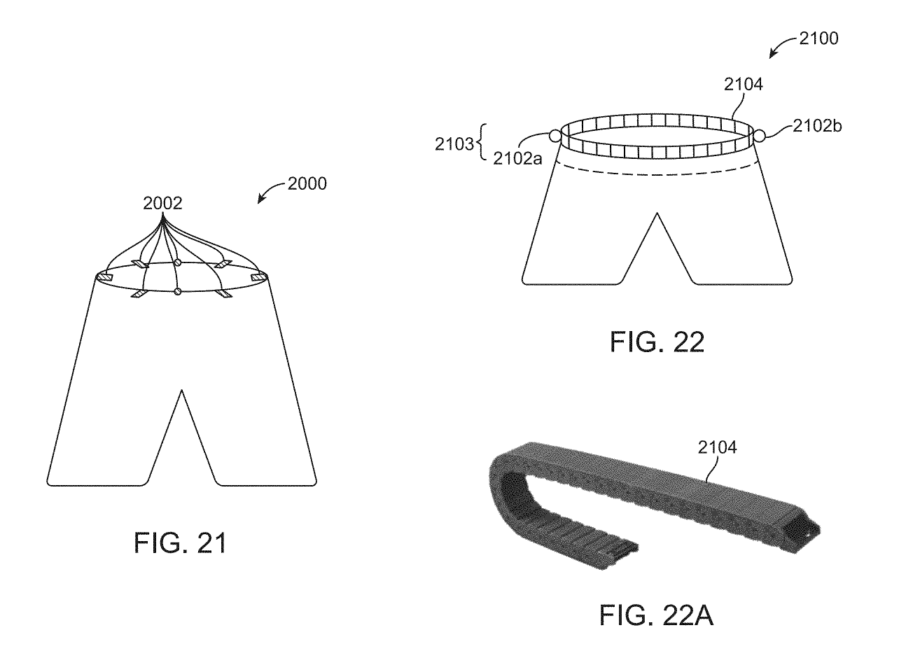

Another exemplary unweighting garment 5100 with force distribution sections 5108a-d is shown in FIGS. 8A and 8B. The force distribution sections 5108a-d can be configured as overlapping straps, as described in other embodiments above. Furthermore, the garment 5100 includes a plurality of attachment elements 5102 in the waist section 5103 (such as more than two). As shown in FIGS. 8A and 8B, each attachment element 5102 can be placed such that it is coupled with a force distribution section 5108a-d. In one embodiment, every force distribution section 5108a-d that extends into the waist section 5103 includes a corresponding attachment element 5108a-d. As shown, the shorts 5100 include six attachment members 5102 distributed along the waist 5103 of the garment 5100. Although shown as having six attachment members in FIGS. 8A and 8B, it can be appreciated that any number of attachment members, e.g. two or more may be used. FIG. 21, for example, shows a garment 2000 including eight attachment members 2002. Using a plurality of attachment members advantageously spreads the unweighting force across a larger area 207a-b of the waist, which stabilizes unweighting to prevent falls. FIG. 9 shows a cross-section of the user's waist in FIGS. 8A and 8B where the user is suspended by cables or tensioning cords 402 from the waist. The unweighting load force is spread over a larger area of the waist sections 207a-b.

Another exemplary unweighting garment 2100 is shown in FIGS. 22 and 22A. The garment 2100 includes a rigid structure or belt 2104 surrounding the waist portion 2103. The belt 2104 can act as a force distribution section and can thus distribute force from two attachment points 2102 around the entire belt 2104. In some embodiments, the belt 2104 includes articulating members. In some embodiments, the belt 2104 can be a rigid ring that extends the entire circumference of the waist 2103 of the garment 2100. In use, the belt 2104 may allow lift from just the sides of the garment (i.e. applied to attachment elements 2102a,b) to be transmitted more evenly along the entire circumference of the waist 2103 of the garment (and thus at or around the circumference of the user's hips).

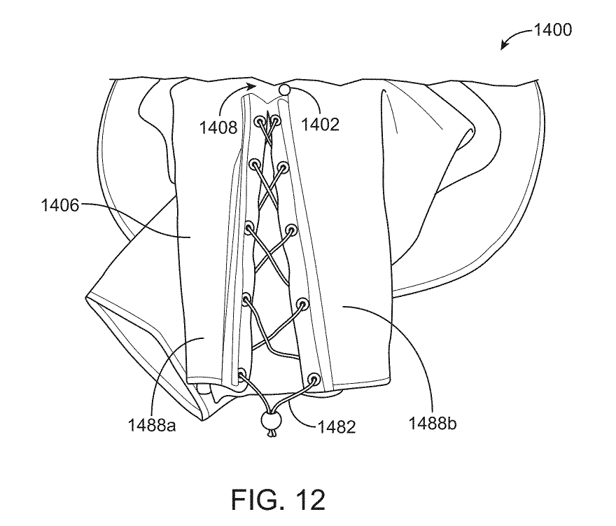

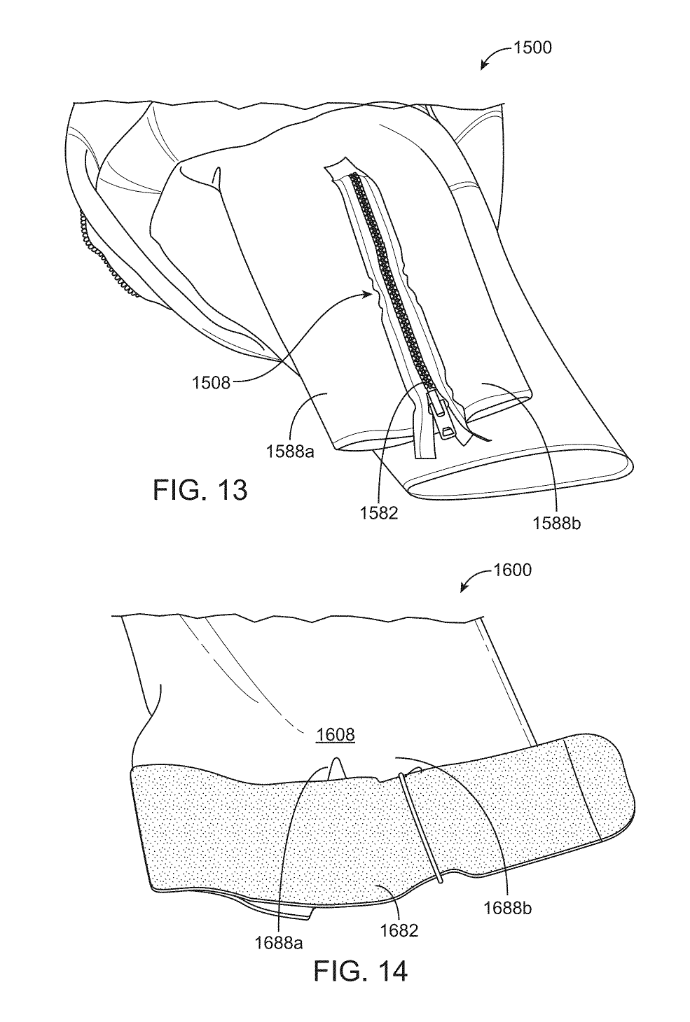

Another alternative embodiment of an unweighting garment 1400 with a force distribution section 1408 is shown in FIG. 12. The force distribution section includes one or more panels 1488a,b in each leg portion 1406 (only one leg portion is shown in the side view of FIG. 12) that are cinchable with a closing mechanism, such as the lacing system 1482. Other cinching mechanisms include hooks, laces, buckles, buttons, Velcro, zippers, etc. When cinched down, the force distribution section 1408 can cause compression on the user's leg(s), thereby allowing force applied to an attachment mechanism 1402 to be transferred throughout the leg portion 1406. A similar garment 1500 is shown in FIG. 13 (where force distribution section 1508 includes panels 1588a,b that are cinched together with a zipper 1582). Another similar garment 1600 is shown in FIG. 14 (where force distribution section 1608 includes panels 1688a,b that are cinched together with Velcro 1682).

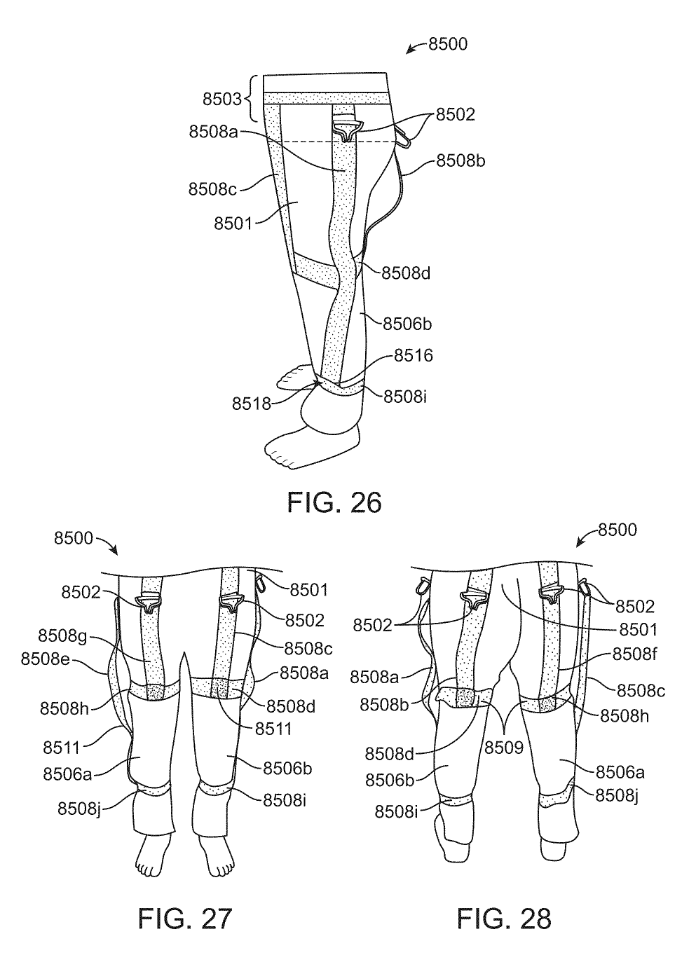

Another exemplary garment 8500 with force distribution sections 8508a-j is shown in FIGS. 26-28. The garment 8500 can be shaped as pants and include a main body 8501 including a waist section 8502 and leg members 8506a,b. Attachment elements 8502 can be placed within the waist section 8502. The force distribution sections 8508a-f can be straps that extend from the attachment elements 8502 and/or overlap with one another. Further, the force distribution sections 8508a-j can extend longitudinally down the length of the user's leg and/or across a portion of the user's leg. For example, a force distribution section 8508a extends lengthwise down the outer side of leg member 8506b from the user's waist to the user's ankle or lower calf area above the ankles (while a corresponding force distribution section 8508e extends lengthwise down the side of the opposite leg member 8506a). Similarly, the force distribution sections 8508b,f and 8508c,g extend from the waist 8503 to an area above the knee on the user's backside and front-side, respectively. Additionally, force distribution sections 8508d,h are placed over an area of the respective leg member 8506a,b so as to surround or cover a user's upper leg above the knee. Moreover, force distribution sections 8508i,j are placed around the leg members 8506a,b to surround or cover a user's leg above the ankles. Although, force panels are shown in horizontal, vertical, longitudinal, or transverse orientations, it is can be appreciated that any orientation or number of force panels may be used for unweighting.

The front-side longitudinal distribution sections 8508c,g are attached to the transverse force distribution sections 8508d,h at attachment points 8511. In some embodiments, the attachment point 8511 between the two force distribution sections 8508c,g and 8508d,h has less elasticity relative to the elasticity of the fabric of the force distribution sections 8508c,g and 8508d,h. The front-side longitudinal force distribution section 8508c,g is also attached to the main body 8501 at or near the location where an unweight force, such as a lifting force is applied. For example, FIGS. 26-28 show the front-side longitudinal distribution sections 8508c,g attached to the main body 8501 near an attachment hook 8502 for attaching the unweighting pants 8500 to an unweighting device that provides an unweighting force. Similarly, the backside longitudinal force distribution section 8508b,f is attached to the transverse force distribution section 8508d,h on the backside of the pants 8500 at an attachment point 8509. The attachment point 8509 may also exhibit reduced elasticity (or no elasticity) relative to the fabric of the force distribution sections 8508b,f and 8508d,h. Additionally, the backside longitudinal force distribution section 8508b,f is also attached to the main body 8501 at or near a location where an unweighting force is applied to the garment 8500. The force distribution section 8508a,b may, for example, be attached to the waist 8503 or to the same area of the pants 8500 where hooks 8502 are located. In some embodiments, hooks 8502 are used to couple the pants 8500 to an unweighting device, system, or mechanism. A lateral longitudinal force distribution section 8508a,e extends from the waist section 8503 to the end of each leg member 8506a,b. At one end, the lateral force distribution section 8508a,e is attached at or near the waist section 8503 and/or at or near the hooks 8502. At the other end, the lateral force distribution section 8508a,e is attached to a distal transverse force distribution section 8508i,j located at or near the distal end of the respective leg member 8506a,b. The lateral force distribution section 8508a,e may be attached to the distal transverse force distribution section 8508i,j at a connection point 8516. The connection point may exhibit reduced (or no elasticity) relative to the other panels 8508i,j and 8508a,e.

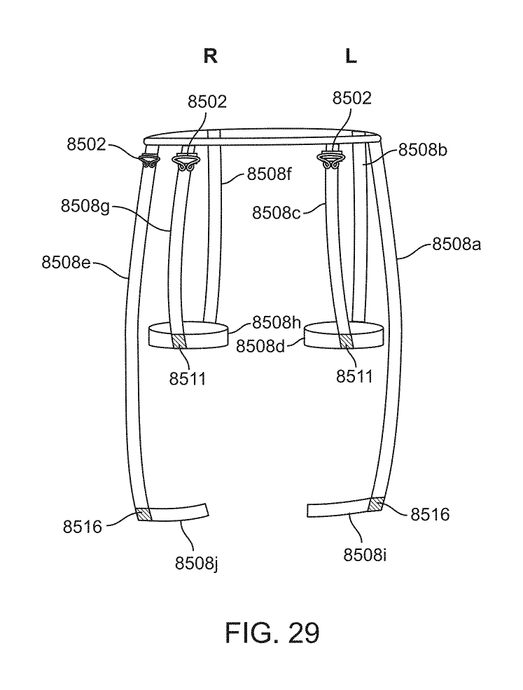

FIG. 29 shows the force distribution sections of the garment 8500 shown in the FIGS. 26-28 with the main body 8501 removed. In some embodiments, as shown in FIGS. 26-29, the lateral longitudinal force distribution section 8508a,e is not attached to a transverse force distribution section 8508d,h near the area adapted to cover or surround the knee of the user. This allows a user wearing the unweighting pants 8500 to rotate her knees without any interfering force from the lateral force distribution panel. In some embodiments, the transverse panels and/or panels that are oriented across the leg as opposed to along the leg length exhibit a slight compressing force against the user when worn. For example, the transverse panels may be designed to be fitted or snugly fitted around the user's leg.

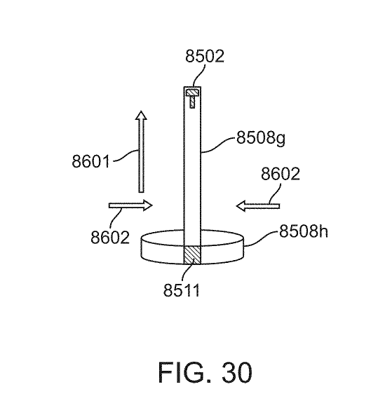

The unweighting pants 8500 of FIGS. 26-28 may assist in comfortable force distribution during unweighting. For example, as shown in FIG. 30, an upward lifting force (shown by arrow 8601) may be applied to the front-side longitudinal force distribution section 8508g when a user wearing the pants 8500 is coupled to an unweighting device. A hook 8502 may be attached to a mating member on the unweighting device or system and the unweighting system may exert a lifting force on the hook 8502 to thereby lift the garment 8500 to unload a portion of the user's weight. The force applied to the front-side longitudinal force distribution section 8508g has a tendency to lift the pants 8500 upward on the user, which could cause sliding of the pants upward on the user to create uncomfortable pressure points (e.g. around crotch area). However, because the front-side longitudinal force distribution section 8508g is attached to the transverse panel 8508h, the lifting force can lift the user partly from the transverse panel 8508h. In some embodiments, the transverse panel 8508h applies a compressive force (shown by arrow 8602) against the adjacent leg area when a lifting force is applied to the garment 8500. Similarly, any of the transverse and longitudinal panels contemplated can distribute or apply forces as described to assist in comfortable unweighting.

In some embodiments, pants (as shown in FIGS. 26-28) may be desirable as an alternative to shorts. For example, in some embodiments, the fabric of shorts are designed to snugly fit around the user's thighs to prevent upward sliding of the garment during unweighting (e.g. prevent ride up of the material). However, with a pair of pants, the upward sliding of the garment during unweighting can be mitigated by the force distribution panels. For example, the distal transverse force distribution section 8508i,j shown in FIG. 26 can be designed to hold the end of the leg member around the user's ankle to prevent upward sliding of the pant leg. This prevents the garment material of the main body 8501 from riding up and causing discomfort. Because the transverse force distribution section 8508i,j prevents sliding of the garment 8500, the main body 8501 may be designed to snugly fit the user's body. In other words, the pants may be worn more loosely relative to the shorts in some embodiments. Additionally, the material for the pants may exhibit relatively less elasticity compared to the shorts. Furthermore, as can be appreciated in the art, the movement and shape of a user's thighs during motion remain relatively the same, whereas the movement and shape of the user's knees and lower legs exhibit greater variability during motion. Accordingly, some embodiments of unweighting pants contemplated provide the user the experience of relatively constant or consistent unweighting and/or lifting during unloading even while the user's knees and lower knee position and shape may vary during motion.

Although shown as having a six longitudinal force distribution panels and two sets of transverse force distribution panels in FIGS. 26-30, it can be appreciated that any number and orientation of the force distribution panels may be used to provide the user a comfortable unweighting experience.

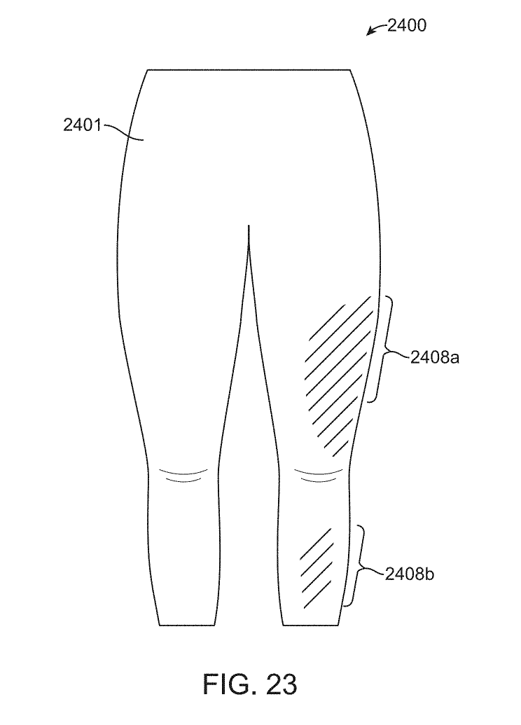

FIG. 23 shows another exemplary garment 2400 formed as pants rather than shorts. The garment 2400 can include force distribution sections 2408a,b and a main body 2401. The force distribution sections may be placed on anywhere suitable on the pants for distributing forces associated with unweighting. For example, the pants may include force distribution sections above or below the knee, below the calf, near the ankle, and/or below the foot. The force distribution sections may employ stretchable compression fabrics such as fabrics that are woven to compress against the user's nearby body part when an unweighting force is applied to the user's hip area.

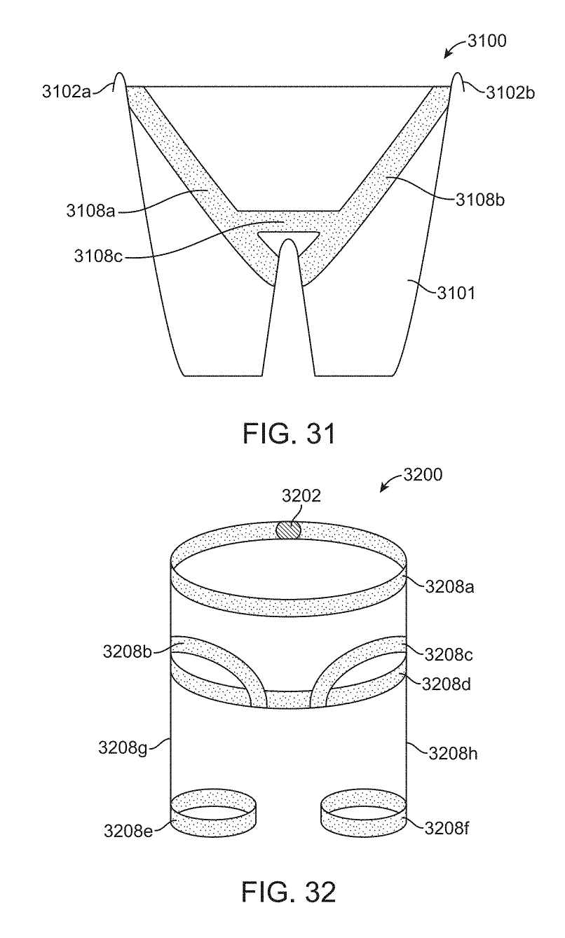

Another exemplary unweighting garment 3100 with a main body 3101 and force distribution sections 3108a-c is shown in FIG. 31. The force distribution sections 3108a-c can extend from attachment elements 3102 down the back of the garment 3100 to sit just below the gluteus maximus. The gluteus maximum advantageously has the appropriate geometry to lift with and is designed to take pressure. Further, lifting with the gluteus maximum advantageously avoids placing lifting forces in the user's groin. The force distribution sections 3108a-c can be straps, panels, and/or seams that control the stretch of the garment 3100. One or more of the force distribution sections 3108a-c (note that all of the sections can be merged as one single piece) can extend below the buttocks to lift the butt cheeks as the user is unweighted. Thus, force distribution section 3108c can extend just below the buttocks to provide a “seat” while force distribution sections 2108a,bcan extend from the attachment element, extend across or just under a butt cheek, and then connect with the force distribution section 3108c. In some embodiments, the force distribution sections 3108a-c can continue to the front of the garment 3100 or the garment 3100 can include additional force distribution sections on the front. In other embodiments, force distribution sections 3108 are only located on the back of the garment 3100. The feel and area of lift can be varied by changing the amount of stretch in the force distribution sections, the width and location of the force distribution sections, the padding between the user and the force distribution sections, how the force distribution sections are coupled to the lifting mechanism, and whether the force distribution sections are additionally secured in place. In use, a force applied to the attachment element 3102 can be transferred through the force distribution sections 3108a,b,c from the sides of the user's hips over and/or around the user's buttocks. In particular, the force distribution section 2108c can provide push vertically on an underside of the user's buttocks.

Another exemplary unweighting garment 3200 having force distribution sections 3208a-h is shown in FIG. 32. The unweighting garment 3200 can configured as a stand-alone harness or it can be a part of a main body (such as shorts, pants, etc.) as described with respect to other embodiments above. The force distribution sections 3208a-h can be configured as straps. One force distribution section 3208a can be configured to encircle the user's hips to distribute force placed on the attachment element 3202 (shown here in the center front of the garment 3200). Force distribution sections 3208g,h can extend axially down the sides of the user's legs to the force distribution sections 3208e,f, which can encircle the user's legs (such as thighs). Further, force distribution sections 3208b,c,d can be configured to support the user's gluteus maximus. One force distribution section 3208d can thus be configured to extend directly underneath the buttocks while force distribution sections 3208b,d can curve from the force distribution section 2308d so as to encircle or extend across the butt cheeks to provide additional support. In use, therefore, a lifting force applied to the attachment element 3202 can be transferred through the force distribution sections 3202 from a single point around the user's waist, down the legs of the user, around the legs of the user, and/or underneath and around the user's buttocks.

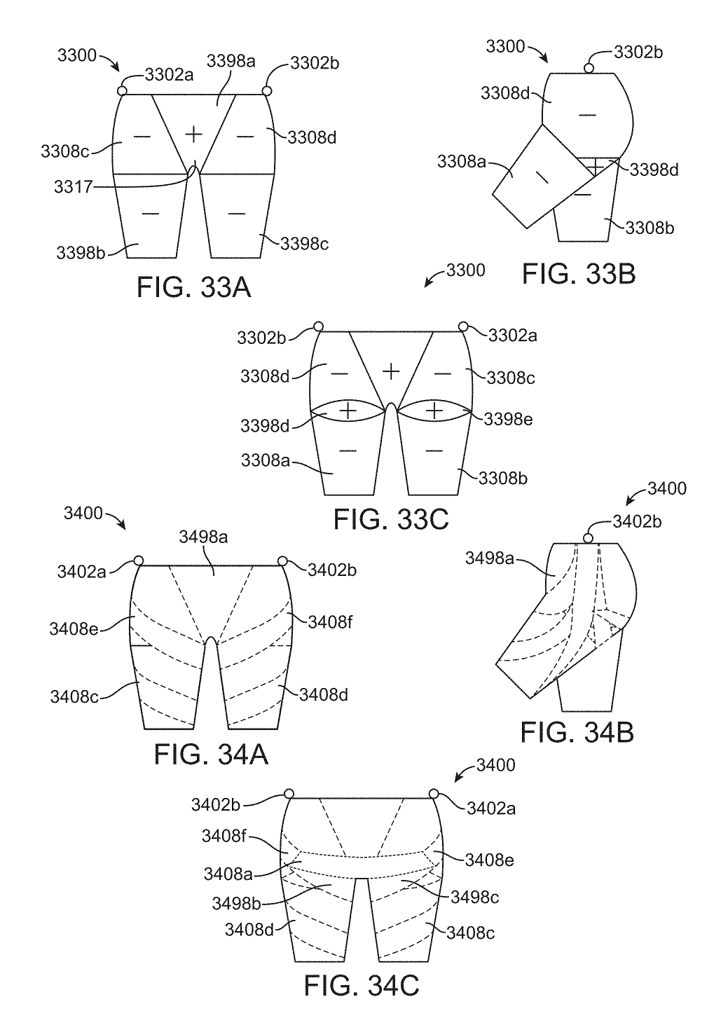

Another exemplary unweighting garment 3300 is shown in FIGS. 33A-33C. The unweighting garment 3300 includes fabric sections of different load response characteristics to provide the desired force in the overlapping physiologic zone. Thus, for example, a section 3398a configured to sit in the crotch area 3117 can be made of a four-way stretch fabric so as to avoid placing pressure on the user's groin. In contrast, force distribution sections 3308a,b can be made of two-way stretch fabric configured to stretch vertically and compress radially, thereby distributing the forces around the upper legs (such as the thighs and hamstrings) of the user. Similarly, force distribution sections 3308c,d bordering attachment mechanisms 3302a,b can be made of a two-way stretch fabric. Further, there can be a point of connection between each force distribution section 3308a,b,c,d and at least one of the attachment elements 3302a,b. Small force distribution sections 3398d,e in the backs of the legs just under the gluteus maximum can include four-way stretch fabric, thereby providing flexibility for movement of the leg (as shown in FIG. 33B). In use, a lifting force applied to the attachment mechanisms 3302a,b can transfer force from outside the user's hips through sections 3308 to or around the user's hips and legs while avoiding the user's groin.

Another exemplary unweighting garment 3400 is shown in FIGS. 34A-34C. The unweighting garment 3400 includes a plurality of different fabric panels having different load characteristics so as to distribute the load as desired. For example, the unweighting garment 3400 includes a force distribution section 3408a configured as an elastic butt support. Further, force distribution sections 3408c,d are configured as elastic lower thigh lift reinforcements while force distribution sections 3408e,f are configured as elastic upper thigh lift reinforcements. The force distribution sections 3498a-d can be, for example, two-way stretch fabric or any other type of force distribution material described herein. Areas near the crotch 3498a and just under the buttocks 3498c,d can include four-way stretch fabric to allow for movement and avoidance of pressure in those areas. In use, a force applied to the attachment mechanisms 3403a,b can be transferred through sections 3408 around or underneath the user's legs and buttocks while avoiding the groin area.

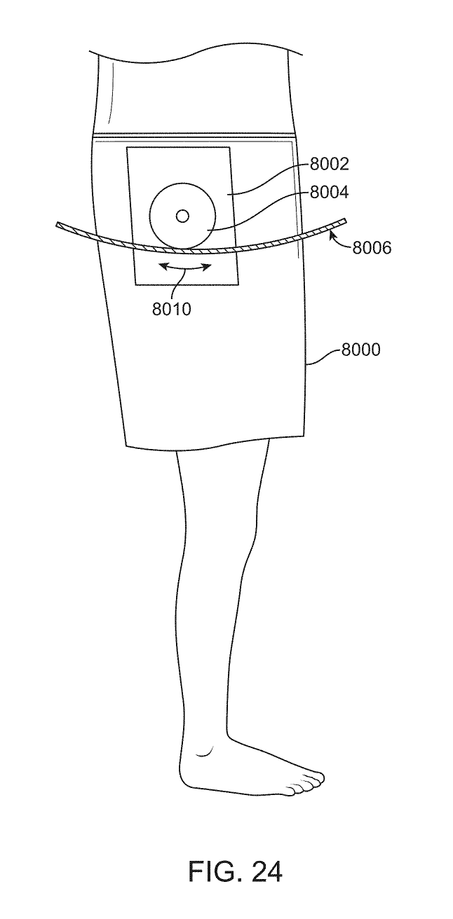

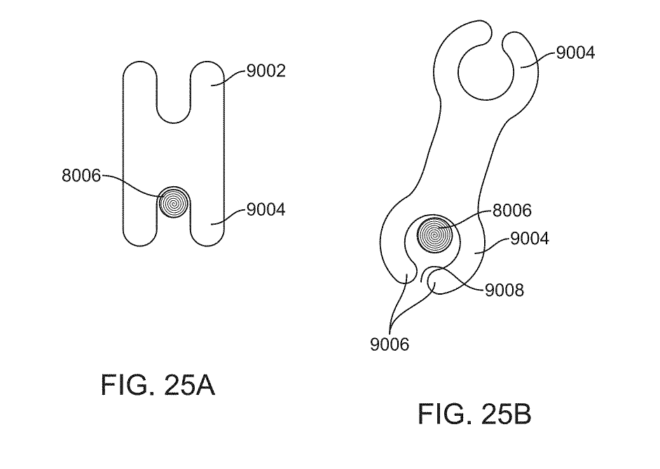

The attachment elements for the garments described herein can be any attachment element capable of releasably fixing the garment to an unweighting machine. For example, the attachment element can include a pulley or roller. FIG. 24 shows a garment 8000 (a pair of shorts) with attachment member 8002. The attachment member 8002 is adapted for coupling the shorts to an unweighting system. In some cases, the attachment member 8002 attaches to a cable 8006 configured to sit on a suspension unweighting system. The attachment member 8002 may include a roller or pulley that contacts the cable 8006 and allows the user to slide along the length 8010 of the cable 8006. FIGS. 25A and 25B show cross-sections of pulleys or rollers that can be used as attachment elements. FIG. 25A shows a pulley with a cable 8006 running through a receiving portion 9002. The receiving portion is recessed to retain the cable within the receiving portion 9002. FIG. 25B shows a receiving portion 9004 with arms 9006. The opening 9008 between arms 9006 may be designed to be smaller than the cross-section enclosed by the arms 9006. In such cases, the cable 8006 may be squeezed or pressed through the opening 9008 into the larger area. The opening 9008 is small enough to prevent the cable 9006 from easily detaching from the pulley.

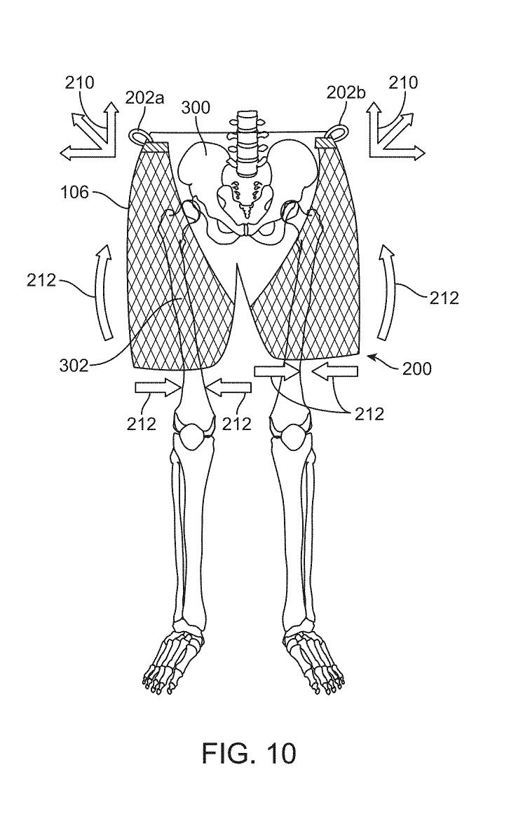

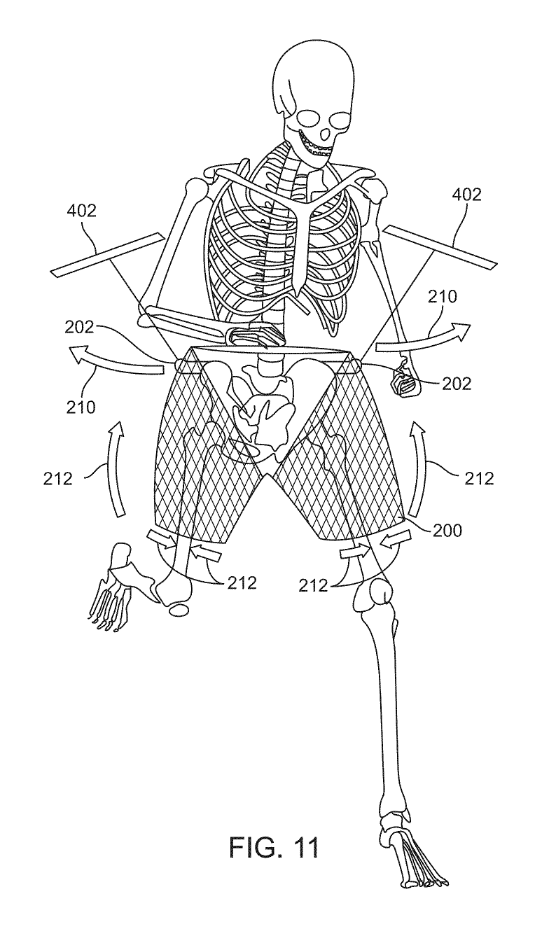

The unweighting garments described herein can advantageously be used to spread the unweighting force out across the user's body to avoid unwanted pressures and rotations. Exemplary garment embodiments similar to those described above are shown in FIGS. 10 and 11 on a user skeleton. It is to be understand that any of the garments above can work similarly and/or produce similar forces on the user as described with respect to one or more of FIGS. 10-12.

FIG. 10 shows the force distribution for a garment 200 consisting of shorts having force distribution section 108a,bwoven fabric that stretch vertically and compress axially. When an unweighting force (shown by the arrows 210) is applied to unload a portion of the user's weight from the hips 300 (such as at attachment mechanisms 202a,b), the unloaded weight is spread more evenly across the user's legs (shown with femurs 302) and hips 300. In some embodiments, this is accomplished by stretching the force distribution section 108a,b. When stretched (e.g. vertical stretching), the fibers of the force distribution sections 108a,b surround and compress against the user's legs. In some embodiments, the force distribution section contracts horizontally, compressing against the user's legs. This allows the force distribution section to carry more of the user's unloaded weight as both tensile and compressive forces (shown by arrows 212) without having the shorts ride up or create uncomfortable stress concentrations. During unweighting, the force distribution section distributes the force such that the user is lifted from a greater area of the garment.

FIG. 11 shows the user running while unweighted in the unweighting shorts 200. Suspension lines 402 are attached to the attachment elements 202 of the garment 200 and provide a lateral lifting force (shown by arrows 210). The shorts convert the lateral lifting force into an unweighting force (shown by arrows 212) that is spread more evenly along the user's legs.

In some embodiments, the force distribution sections (such as the fiber weave) place a force on the thighs that changes the centers of force from the outside of the hips, where it applies a force pulling legs outwards, to be more in line with the hip joint, where the force will have a neutral effect on the legs. In some embodiments, the shorts move the center of force and distribute the force by use of a rigid member. In some embodiments, the user is unweighted from the sides (or laterally). Embodiments described herein are compatible with any type of suspension unweighting regardless of the angle or direction of the lifting force.

Aspects of the various embodiments described herein advantageously include one or more innovations that assist in overcoming the shortcomings of existing unweighting garments, mechanisms, or systems. Particular areas of improvement provided by the embodiments described herein include: (1) circumferential force conversion; (2) zoned differential compression; (3) hip joint neutrality; (4) quick attachment and detachment; and (5) and ease of access. Each of these general areas will now be described.

Circumferential force conversion: When vertical lifting force is applied to a garment of uniform material content, the garment tends to ride upwards on the user until the garment binds against the user's crotch area. Because users vary widely in size and proportions, shaping the garment has limited utility in this regard. Some of the embodiments described herein utilize materials cut and aligned on the bias in relationship to the vertical lifting force. When biased sections are pulled upwards by the lifting force, the cross-sectional areas contract, causing circumferential tension and a resulting radial compression proportional to the lifting force. Embodiments relating to aspects of this improvement include, for example, with the embodiments of FIGS. 1, 3, 4, 5, 8A, 10, 11, 15, 16, 19B, 20A, 20B, 20C and 23.

Zoned differential compression: With regards to the application of unweighting or lifting forces to the body via the suspension interface garment, different parts of the anatomy have different characteristics that make them more or less suited to the application of said forces. For example, the hips have high load tolerance and low taper. The thighs have moderate load tolerance (femoral artery) and moderate taper. The crotch or groin has no load capability and high taper. As such, different areas of the body need to be loaded differently to achieve a proper balance between maximum unloading and comfort. Embodiments relating to this improvement include, for example, the embodiments of FIGS. 1, 3, 4, 5, 10 and 11.

Hip joint neutrality: While DAP loads the user's lower body uniformly in terms of area with respect to air pressure and circumferentially with respect to garment tension, non-DAP systems that do not inhibit upper body motion tend to support the lower body garment at two discrete points, one at either side of the pelvis. Since the hip joints are inboard of where the unweighting loads are typically applied in these systems, an unnatural lateral torque pulls the legs out to the sides. At low loads and/or for short durations, this effect may not be noticeable. At higher loads or for longer duration usage, this becomes an issue. The embodiments described herein address this need in two ways. In one method, unweighting load attachment points are placed fore and aft, in line with the hip joint, to minimize the lateral moment. In another method, bands cross the pelvis from their attachment points, applying an inward force and counterbalancing moment on the opposite leg, resulting in a net zero moment. Embodiments relating to this improvement include, for example, the embodiments of FIGS. 6, 7A, 7B, 8A, 8B, 9, 10 and 11.

Quick sliding attachment/detachment: Current unweighting and safety systems provide fixed attachment points with respect to fore and aft movements of the hips. This constraint, while fine for gymnastic and strength movements, unnaturally inhibits hip rotation during running and walking. The current design allows for independent fore and aft motion. Embodiments relating to this improvement include, for example, the embodiments of FIGS. 15, 24, 25A, 25B and 26-30.

Ease of access: There is also a need to address the difficulty of accessing known harness systems when the user desires to remain in street clothes rather than athletic gear or wants to exercise in an unweighted environment while avoiding the process of removing and putting back on shoes. Each of the embodiments described herein may be sized in order to be worn over clothes. FIGS. 12, 13, 14 and 26-30 in particular relate to unweighting garment embodiments that may be donned by a user while still wearing shoes.

As described herein, there are several unweighting systems utilizing either differential air pressure (DAP), mechanical unweighting or overhead lifting devices separately or in combination to remove weight from a user's lower extremities. Regardless of the mechanism being used to provide the actual unweighting forces, an unweighting garment as described herein is used as the interface between the system and the user being un-weighted. In some embodiments, these garments have included harnesses for mechanical lifting systems and airtight shorts for DAP systems, with some instances of shorts being used with mechanical lifting systems in an attempt to provide greater comfort to certain user groups such as runners and heavier users.

In addition, there is also a need for unweighting garments to meet three often conflicting requirements: comfort, speed of access, and maximum unweighting. In still other alternative embodiments, there is also provided unweighting garments adapted and configured to measure physiologic signals such as EKG, EMG, SpO2 and pulse during active exercise or therapy. In some embodiments, there is provided one or more sensor integration packages—depending up on the desired physiological signal to be measured and the locations available for sensor placement given the garments other requirements mentioned above. As described herein are unweighting garments adapted and configured to integrate one or more sensors into an unweighting garment in such a way as to facilitate intimate contact with the user's skin for signal acquisition as appropriate based on the sensor type while also meeting the other unweighting garment functional requirements described herein.

In still further alternative embodiments, any of the above unweighting garments may be modified to provide one or more of a sensor to measuring a physiological signal of a user wearing the unweighting garment. In still further embodiments of any of the above, there is also provided unweighting garments adapted and configured to measure physiologic signals such as EKG, EMG, SpO2 and pulse during active exercise or therapy.

In some embodiments, there is provided an unweighting garment embodiment having one or more motion sensing or motion capture sensors. In one aspect, there is provided an unweighting garment including an inertial measurement unit. In still other unweighting garment embodiments, there is provided on an unweighting garment one or more accelerometers, gyroscopes or other sensors for detecting or measuring user movements. In another aspect, the placement or selection of a particular sensor or combination of sensors is selected and positioned on the unweighting garment to provide user specific data to assess one or more aspects of the user's gait. It is to be appreciated that the one or more sensors or sensor integration packages—depending upon the number of sensors or desired physiological signal or attribute being measured—are positioned within those locations available for sensor placement given the other unweighting garments other design requirements mentioned herein.

In some embodiments described herein, there is provided an unweighting garment having one or more or a combination or a set of a tightening feature, a closure feature and a connection feature that address all three unweighting garment requirements simultaneously. In still further embodiments, there are provided unweighting garments configurations that are also adapted and configured to properly position and maintain secure fixation of one or more or a combination of biometric sensors to improve the experience of users undergoing partial body unweighting therapy and training.

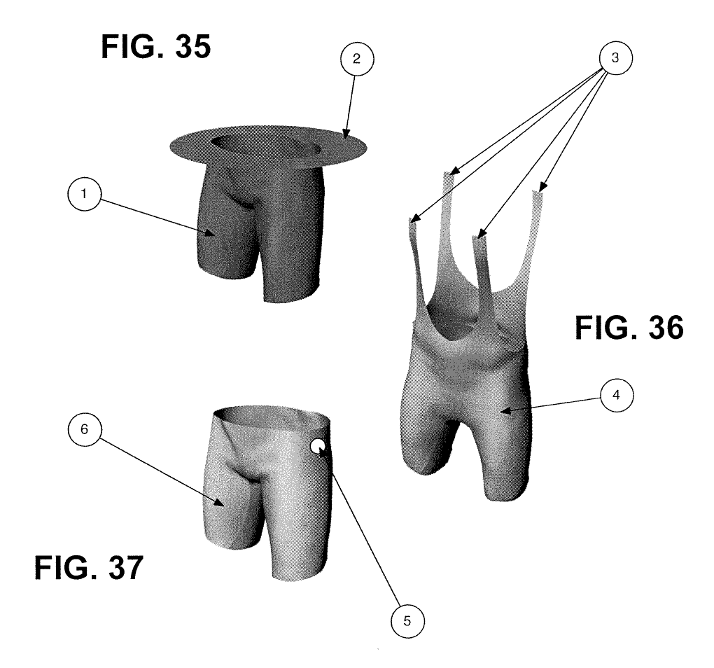

FIG. 35 illustrates a perspective view of an unweighting garment 1 adapted and configured for use with a DAP system. The illustrated unweighting garment 1 may be used in a DAP unweighting system with a flexible skirt 2 that connects the garment 1 to the lower body pressure chamber at its periphery.

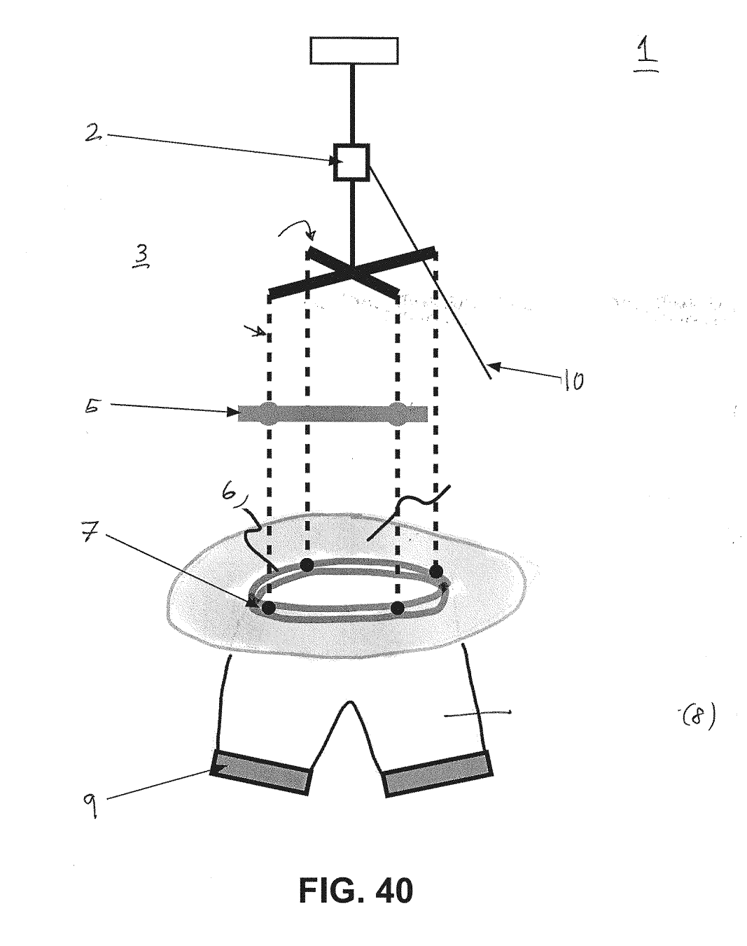

FIG. 36 illustrates a perspective view of an unweighting garment 4 adapted and configured for an overhead suspension, a fall support or other type of user assistance system. The garment 4 in FIG. 36 may be further modified to have more or fewer connection points 3 than the four illustrated. Additionally or alternatively, the unweighing garment 4 of FIG. 36 may be adapted and configured for coupling to a DAP system or a mechanical unweighting system as with garments 1, 6. The illustrated unweighting garment 4 may be used with fall support (see FIGS. 40, 41, 42, 49A-49C) or overhead unweighting systems designed for attaching to the same or suitably configured at lift attachment points 3.

FIG. 37 is a perspective view of an unweighting garment 6 adapted and configured for connection to a mechanical unweighting system. The illustrated unweighting garment 6 is used with hip-attached unweighting systems, attaching mechanically at hip points 5. Various alternatives are described herein with regard to FIGS. 1-34.

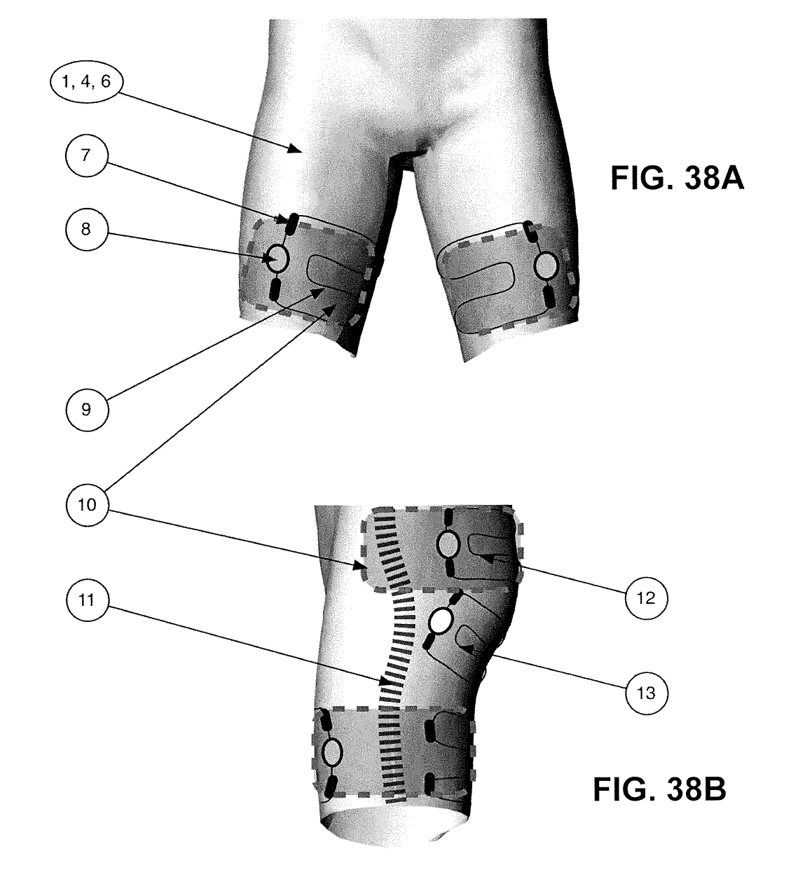

FIGS. 38A and 38B are front and side views, respectively, of a variety of unweighting garment features that provide a custom fit to the user via a set of strategically located tightening mechanisms may be modified in many different ways to accommodate unweighting garment designs for users in User Categories 1, 2, 3, and 4. It is to be appreciated that the illustrated unweighting garments 1, 4, and 6 from FIGS. 35, 36 and 37 and those other garments described herein may be adapted and configured to include one or more of the illustrated closure and fit adjustment features 80. When unweighting garments are provided with one or more such fit adjustment features 80, then the unweighting garment may be fitted to the user via a set of strategically located tightening mechanisms, which allow easy access to the garment when loosened, and firm support when tightened. In one embodiment, each tightening mechanism 80 consists of cable guides 7, cable tensioners 8, and tensioning cables 9, 12, 13. As different areas of the body possess different sensitivities to pressure, separate tightening mechanisms are provided for zones identified for their ability to sustain lifting forces such as the lower thighs, the gluteus, and the hips, for example.

Various different cable systems and tightening mechanisms may be incorporated into the various unweighting garment fit adjustment feature 80 embodiments including for example a reel, a ratchet, a lever, a two speed lever, a two speed knob, a two speed reel, a bidirectional reel, a bidirectional level, a bidirectional knob and the like. In still further alternative embodiments, the tightening mechanism may include features as in those tightening mechanisms illustrated and described in U.S. Pat. Nos. 2,991,523; 3,738,027; 4,961,544; and 8,443,501; 8,468,657 and 8,832,912, each of which is incorporated herein by reference in its entirety.

FIGS. 38A and 38B also illustrate representative sensor zones (10) where one or more wired or wireless sensors may be placed. Within the representative sensor zones 10 it is believed that sensors are pressed into intimate contact with the user's body because of the form factor alone or in combination with the use of one or more fit adjustment features 80. Still further alternatives specific placements may be determined based on a number of factors such as whether good skin-sensor contact is needed/achieved and/or whether user motion is being detected and if so, the type of motion as well as sensor placement so to not interfere with other functionalities provided by the unweighting garment. Sensor zones 10 may be provided in any of a number of various locations where one or more characteristics or parameters of the body is measured. The sensor location on and attached to the garment is selected based on the characteristic or parameter and the best way to provide detection and measurement of the characteristic or parameter.

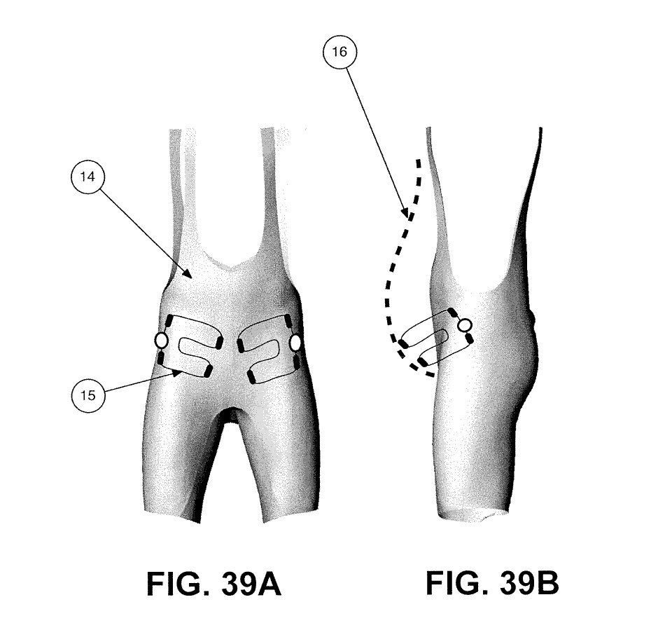

FIGS. 39A and 39B are front and side views, respectively, of a variety of unweighting garment features that may be modified in many different ways to accommodate unweighting garment designs for users in User Category IV. In the special case of an obese or Category IV user, an additional lifting area is identified in the abdominal region. In this case, Category IV user garments 14 are fitted with tightening mechanisms 80 positioned under the users' abdomen as shown by profile 16. The cable tensioner 8 and guide cable 7 are arranged about the user abdominal profile 16 to provide the abdominal cable 15 to support as illustrated. In one alternative aspect, the Category User IV garment may be advantageously used by an expectant mother who wants to exercise during pregnancy in an unweighted training system. The mechanisms 80 may be adapted and configured to also provide an appropriate and adjustable level of support to the mother's abdomen as needed depending upon pregnancy stage and the mother's overall suitability to unweighted therapy.

In some additional embodiments, a garment worn by a user adapted and configured to couple the user to an unweighting system (i.e., DAP or mechanical unweighting system) may also be modified to releasably couple to a fall safety device that operates in relation to the unweighting system. The fall-safe garment embodiments described herein could be supported overhead by attachment to a fixed point of support for fall safety or to a system that has an adjustment mechanism for vertical lift or variable vertical support.

In addition, the overhead support may be fixed in position or may include a translational trolley that maintains support as the supporting element moves along a lateral structural element. The trolley may be powered or unpowered roller system. In one embodiment, a plurality of lift attachment points are integrated directly into a garment designed for use in a DAP system so that a single garment, once donned by a user then meets both the requirement of creating a substantially airtight seal in a DAP pressure chamber while also providing one or more attachment points for an overhead lift, fall safety or upper body stability system. In one aspect, an unweighting garment adapted and configured for use within an unweighting system is modified to provide for one or more connections to an embodiment of a fall safety system. As a result, a user puts on a single unweighting/fall safety garment that is adapted and configured to couple to both an unweighting system and a fall safety system.

In a similar way, garments adapted for use with exercise equipment alone or with other non-DAP unweighting systems may similarly be modified to also provide one or more attachment points for an overhead lift, fall safety or upper body stability system as described herein. In one embodiment, a fall safety device includes a frame integrated to or positioned adjacent to the unweighting system. In this embodiment, a fall safety harness is supported by the frame and moveable between a first position where the user is not using the unweighting system and a second position where the unweighting garment which is donned by the user in the first position is coupled to the unweighting system in the second position. The frame supports a moving connection adapted and configured to support the weight of the user and permit movement between the first and the second positions. A translational support or trolley may be any of a variety of moveable connections including, by example and not limitation, a linear bearing, a roller, a sliding bearing, a rack and pinion or any other suitable coupling permitting movement of the fall safety device relative to the frame in conjunction with user movement relative to the unweighting machine. Connections between the fall safety device and the attachment points to the garment may be one to many, many to many, or many to one or any other combination depending upon the specific garment design, attachment points and safety harness configuration.

Optionally, in some embodiments, one or more of a handle, a strap, a bar or other a stability hand hold is provided for the user within the safety harness device. In one aspect, a bar is suspended between two straps connected to right and left garment points in a position in front of the patient. In still another aspect, there a stop or a latch within the safety device moving mechanism to hold the roller or slider in position. A latch release may be provided within the fall safety harness within reach of the user or an assistant when the fall safety device is coupled to the garment.

In another aspect, the fall safety device operates as a fall protection system in contrast to a powered lift assistance and mobility system as described in other various embodiments. In use, a user wearing a garment adapted and configured for use with an unweighting system attaches one or more straps or connectors from a fall safety device to one or more appropriately configured connection points or couplings provided on the garment for that purpose. In one aspect, the roller or movable connection is adapted and configured to be compatible with or supported by a commercially available overhead frame system such as the PUMA or OASUS commercially available from Enliten LLC (further described at www.enlitenllc.com), or other support frame system modified for appropriate placement relative to an unweighting system. In one embodiment the overhead frame system for supporting the fall safety device is a stand-alone component adjacent to the involved unweighting system. In this configuration, the overhead frame system may be attached to or at least partially supported by the unweighting system. In another aspect, the overhead support system is integrated or formed with or supported by the same base or mainframe as the unweighting system. In one aspect, the support frame is similar in design to that in, for example, FIGS. 1A, 7A, or 7B of commonly assigned, co-pending U.S. Patent Application Publication No. US 2012/0238921 with the modification that the powered lift and movement system is replaced by an embodiment of the translation trolley or other suitable non-powered, moveable fall safety device translation device described herein (i.e., an embodiment of the translation trolley).

In some aspects, garment modifications may take on any of a number of different embodiments to enable releasable attachment to an embodiment of a fall safety device. In one aspect, the straps or lines from the fall safety device terminate in a connection element adapted and configured to attach to a complementary connection element on the unweighting garment worn by the user. In one embodiment, a quick release device such as a snap shackle is incorporated between the user harness and the lift support system. In still another aspect, the straps or lines from the fall safety device are adapted and configured to attach or couple to a strap or line that is connected to the unweighting garment. In another alterative embodiment one or more straps or connectors of the fall safety device is connected to a reel tensioning system permitting slack removal from a strap or connector to adjust the tension or slack of the lines or connectors used in the fall safety device.

In one embodiment, there are provided one or more unweighting garment provided hooks for attachment to one or more associated straps that are part of a fall safety device. Because the various unweighting garments have been adapted for use with the fall safety device the unweighting garment connects directly to the fall safety device instead of having the user wear a separate, harness in addition to an unweighting garment. Advantageously, use of embodiments of multiple function unweighting garments would eliminate the need for a user or a patient to put on a harness for connection to a fall safety system in addition to wearing an appropriate unweighting garment. Wearing a single multiple use unweighting garment would shorten set up time for users of unweighting therapy systems used in conjunction with a fall safety device. In one embodiment, an unweighting garment may be configured to include 4 connection points for coupling to a fall safety device. In one embodiment, the unweighting garment is provided with two connection points in the front of the user and two connection points in the back of the user. In one aspect with a top down view of a clock face imposed over the user with a middle front facing user indicating 12 o'clock and the middle back of the user indicating 6 o'clock, then two front connection points may be positioned at the 10 and 2 o'clock positions, and two connections in the rear position at 4 and 8 o'clock positions. Other numbers and positions of fall safety device connection points are possible and more or fewer straps may be used in the front, the back or both.

In one aspect, one or more connection points for attaching the fall safety device to the unweighting garment are coupled to one or more of an existing strap or support element provided in the unweighting garment design. In one aspect, there are hooks provided on the unweighting garment that are positioned generally about the user's waist for connection to the fall safety device In these and other configurations of multiple use unweighting garments, the user need only put on one garment—not a separate harness—for use with unweighting systems having a fall safety device.

FIG. 40 illustrates an isometric view of an unweighting garment configured for attachment to a fall safety device. In this illustrative embodiment, the unweighting garment is a pair of shorts 8 adapted to provide a DAP seal 11 about the user's torso for use in a differential air pressure (DAP) style unweighting system. Additional details of the DAP seal 11 are provided in commonly assigned U.S. Patent Application Publication No. US 2011/0098615, such as, for example, FIGS. 4A, 4B, 5A-5L, and 6-7F. A plurality of airtight attachment points 7 are provided in the garment 8. The airtight attachment points 7 enable coupling of the load transfer straps 4 or other suitable connectors from the fall safety device to the garment 8.

In one embodiment an attachment point is provided by attaching a loop to an edge of a DAP garment in the desired position. One exemplary location is along an edge of the neoprene seal used for DAP seal 11. Reinforcements or large area attachment points may be provided to prevent damage or tearing of the neoprene.

Importantly, these connects are made without impairing the pressure tight seal maintained by the DAP seal 11. In the illustrative embodiment four attachment points 7 are shown. More or fewer or a different arrangement of the connection points 7 are possible in various alternative aspects. In one embodiment, a load spreader 3 is coupled to the garment 8 and provides a support for the attachment points 7. Advantageously, connection of the attachment points (and subsequent connection to the fall safety device) to the load spreader permits distribution of forces should the user fall and force is applied from the fall safety device to the attachment points. Optionally, the attachment points may be coupled to the garment by other means such as point connections. In one aspect, one or more point connections may also include a large pad for localized distribution of any loads transferred from the fall safety device straps 4. As described elsewhere herein, the unweighting garment may also include one or more or a combination of load transfer straps. The load transfer straps may support the user under, alongside or across various body structures. These straps could wrap around the legs, as would straps in many common harness systems, or could provide transverse lift by passing diagonally from one side to lift points on the other side, or could provide lift through structures that provide gluteal support of the user. Finally, the support straps could simply be enhanced structural supports to strengthen the seal facilitating force distribution through the elastic material of the shorts. In the embodiment of FIG. 40 load transfer straps 12 are provided around the thighs of the DAP garment 8.

FIG. 40 illustrates an overhead transport trolley supported by a frame (not shown) and moveable between a position adjacent to an unweighting system and to a position for using the unweighting system. In the illustrated embodiment, a single connection is provided from the overhead transport trolley to a sit/stand height adjustment mechanism 2. The sit/stand height adjustment 2 is operated using a suitable adjustment controller such as a pull cord, electromechanical adjustment (i.e., motor operated), a pulley (with or without clutch or ratchet) or other device. A load spreader 3 is used as a connection point between the sit/stand height adjustment 2 and the connection straps 4. In the illustrative embodiment, the load spreader is x-shaped to accommodate the 4 straps in the illustrated configuration. Different shapes are possible based on the number of connection straps used in a particular embodiment.

The fall safety device and multiple mode unweighting garment embodiment of FIG. 40 also illustrates a upper body stabilizer or balance support 5 that extends between two of the fall safety device straps 4. In use, a user may grasp the balance support 5 while walking forward to transition from the position off of the unweighting system, to maintain a position for using the unweighting system and then when backing up to return to the off system position when unweighting system use is complete. In an alternative embodiment, the stabilizer or balance support 5 may be a grip, strap or loop attached to one or more of the connectors 4 rather than a bar extending between two straps as shown.

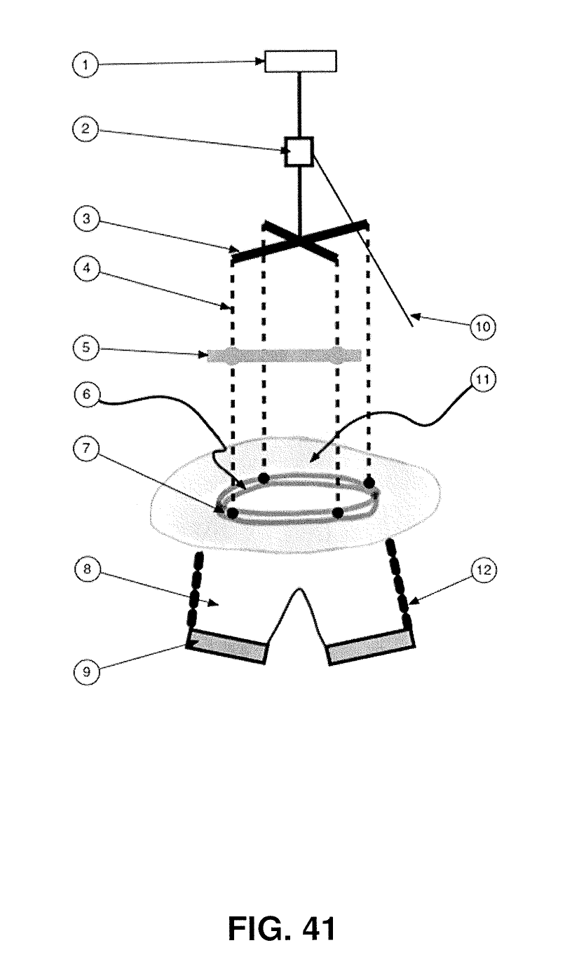

FIG. 41 illustrates another embodiment of a DAP garment integrated with connections for a fall safety device. The embodiment of FIG. 41 is similar to FIG. 40. FIG. 41 also illustrates additional garment load transfer straps 12 used in combination with load straps 9.

Typical support systems used in conjunction with such a fall-safe DAP garment comprise a translational trolley, 1, that can support the user's weight in the event of a fall, a height adjustment mechanism, 2, to accommodate users of different heights and to minimize slack as users transition from sitting to standing, a control means, 10, for actuating the height adjustment mechanism, 2, and a load spreader, 3, to distribute the vertical forces to several attachment points, 7, on the garment, 8. For use with low-mobility patients with compromised trunk control, an upper body stabilizer, 5, may be present for user to grasp or wear to provide upper body fall safety.

In still other embodiments, the airtight attachment points 7 and one or more garment based load transfer straps may be provided by or configured into one or more of any of the above described support garments. Still further, circumferential load 9 and garment load transfer strap 12 are only two of many different types of load bearing garment configurations. By way of example, any of the above described force distribution or unweighting garments may be substituted for or combined with the load transfer straps 9, 12 illustrated in FIGS. 40 and 41.

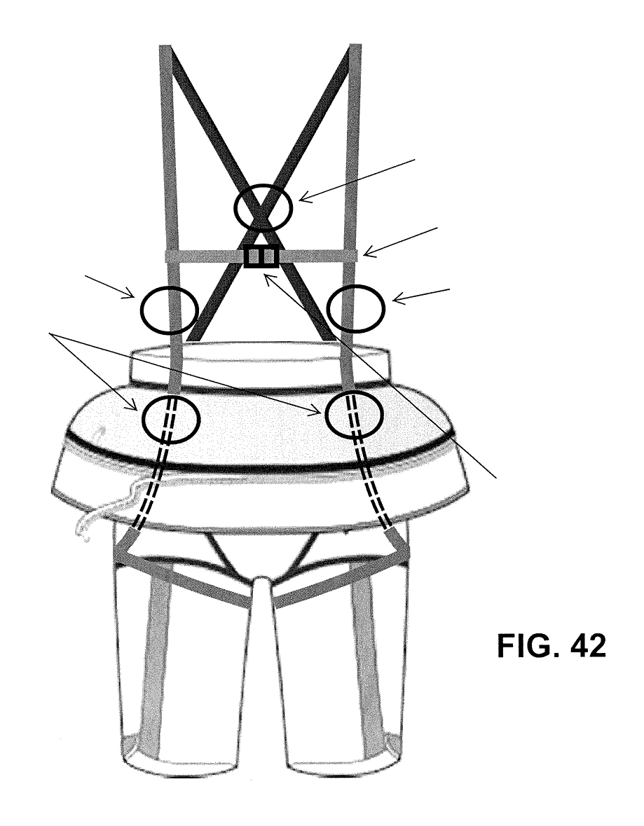

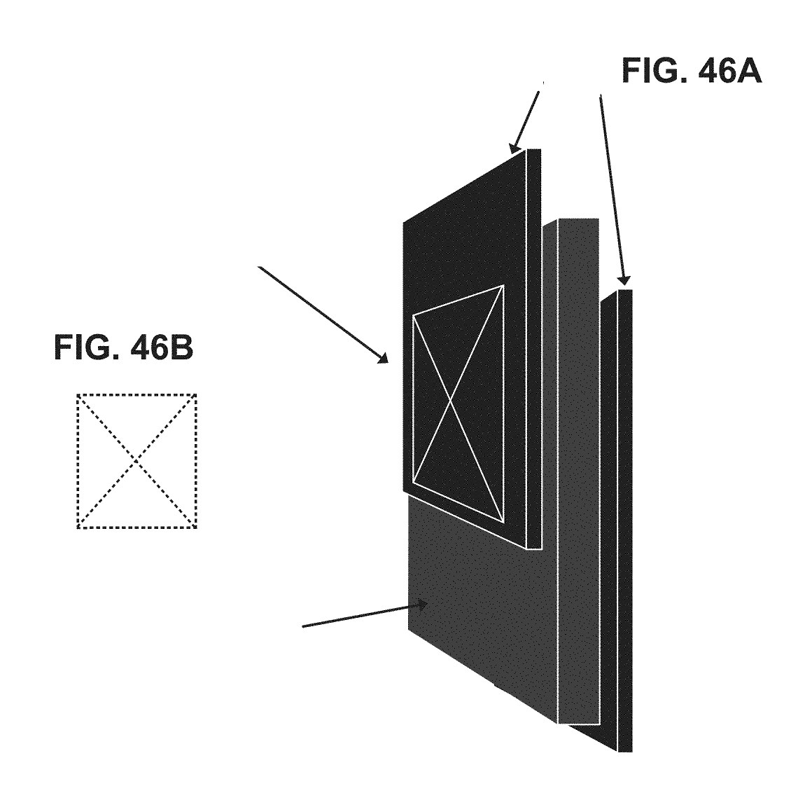

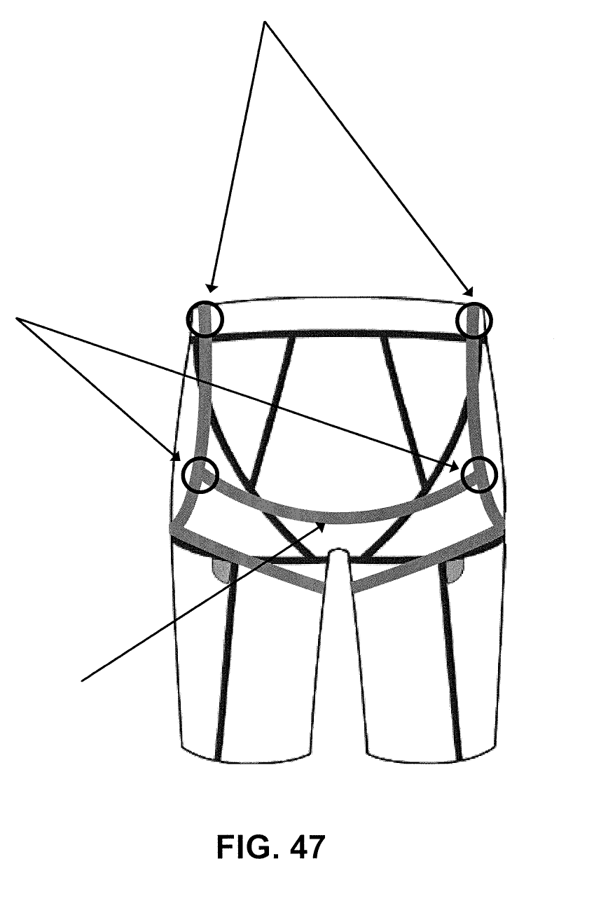

FIG. 42 is a front view of a DAP short and seal with an embodiment of a lift assist support system attached. The lift assist support system is utilized to provide a shoulder strap based system that is connected directly to the garment worn by the user when using either unweighted or conventional exercise equipment. The system includes an adjustable shoulder strap having a crossing in the back and attachment points both front and rear near or on the user's waist. The strap or webbing material is attached to the users garment and then continues on in a pattern as indicated around the user's thighs and waist and buttocks region. The dashed portion in the figure indicates where the webbing is behind the DAP seal. Box stitching is located in the front portion where indicated in the drawing. The box stitch is passed through the air seal gasket and both the shoulder strap and shorts layers of reinforcement material or webbing. Box stitching is further described with regard to FIGS. 46A and 46B.

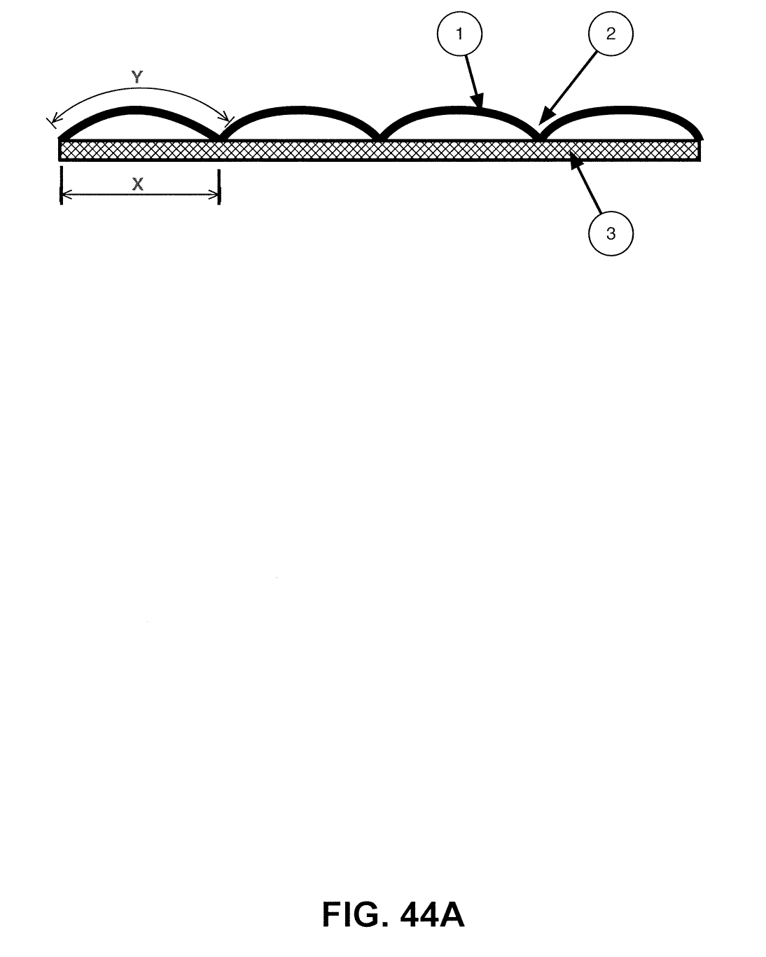

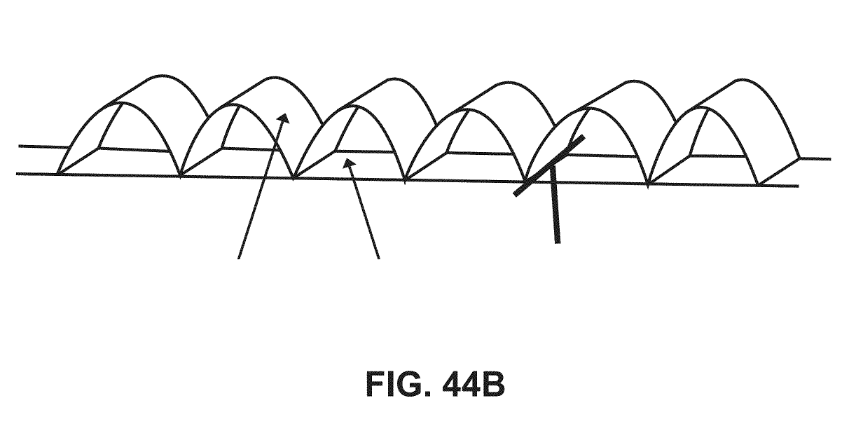

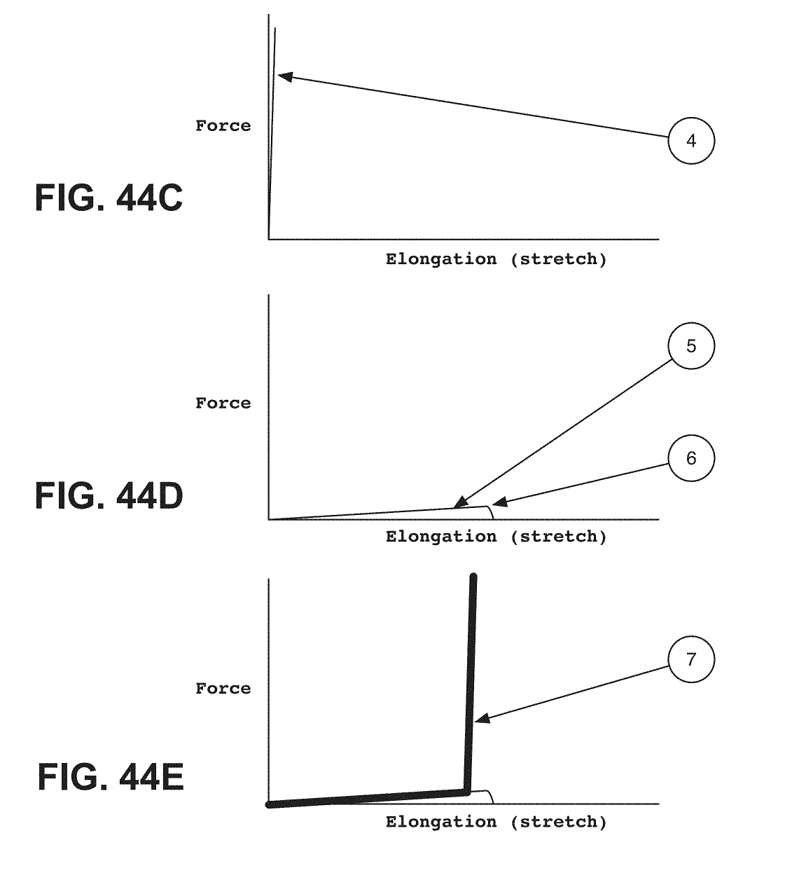

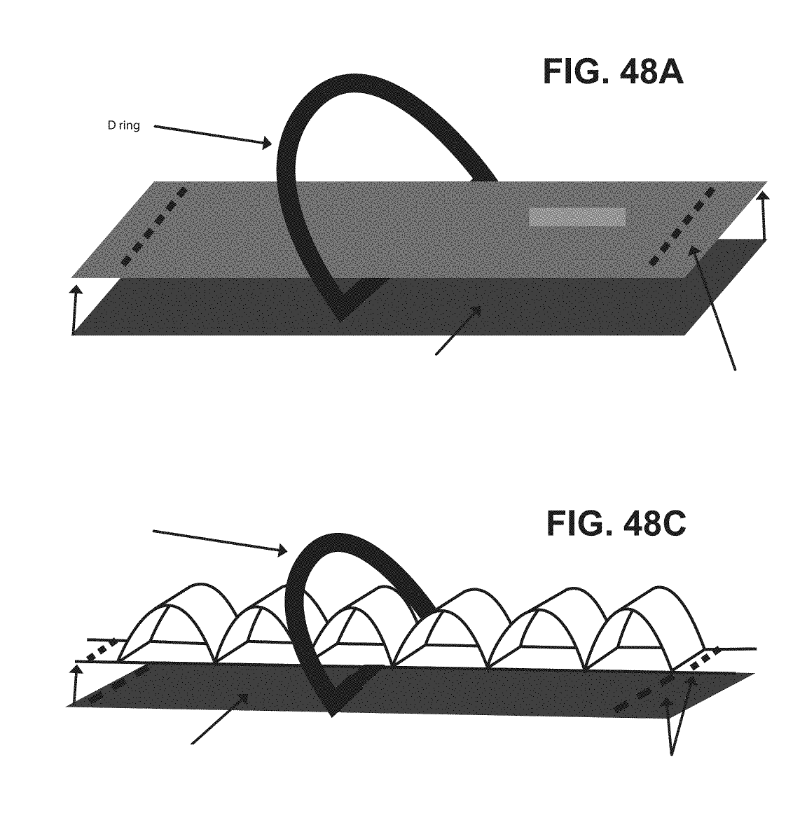

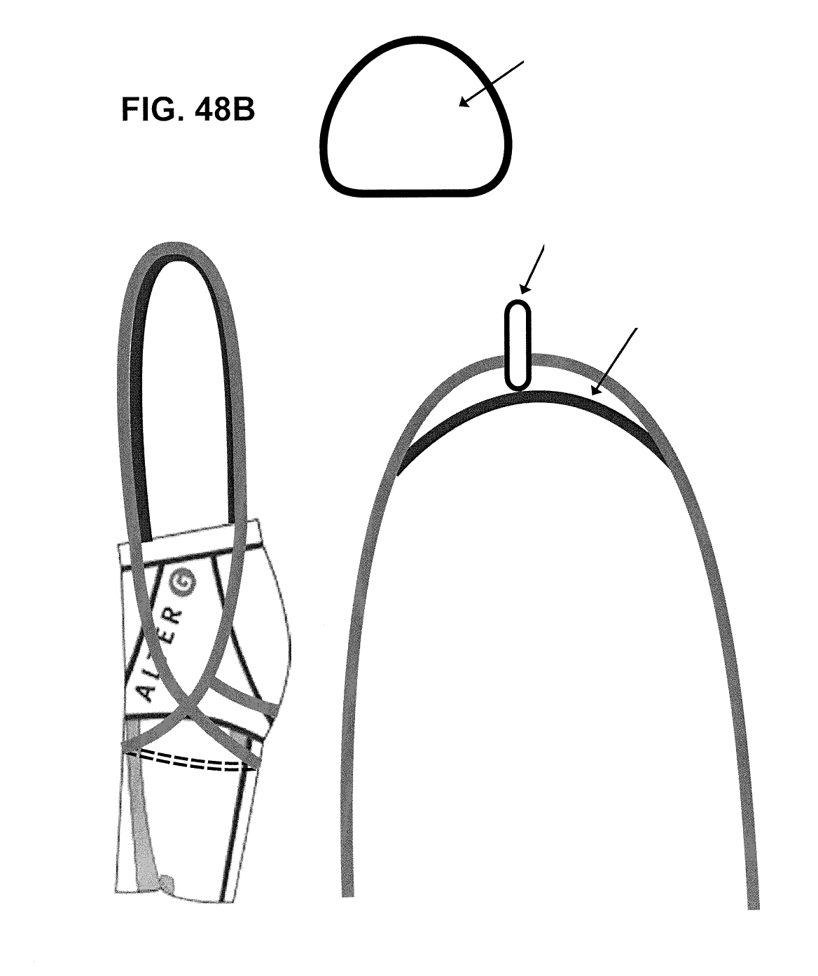

The lift assist support system is an easy to donn and doff harness that in many ways is self-adjusting to the size and shape of the user. The shoulder straps may also include adjustable length buckles at the locations indicated. Additionally an adjustable height chest strap is provided with a release buckle on sliding straps. When the chest strap is properly adjusted, it is used to prevent the user from falling forward. The straps located at the center back of the user are crossed to prevent the user from falling out rearward. Looped webbing material wraps around the thighs but still allows the neoprene shorts to stretch and form to the body of the user in a comfortable manner. (See FIGS. 44A, 44B, 48C) However, if the full weight of the user is brought to bear on the harness the same loops can extend to their full length providing a hard stop for fall mitigation. This makes for a very simple harness to be applied to the user with fewer adjustment points than currently available in conventional harness systems.

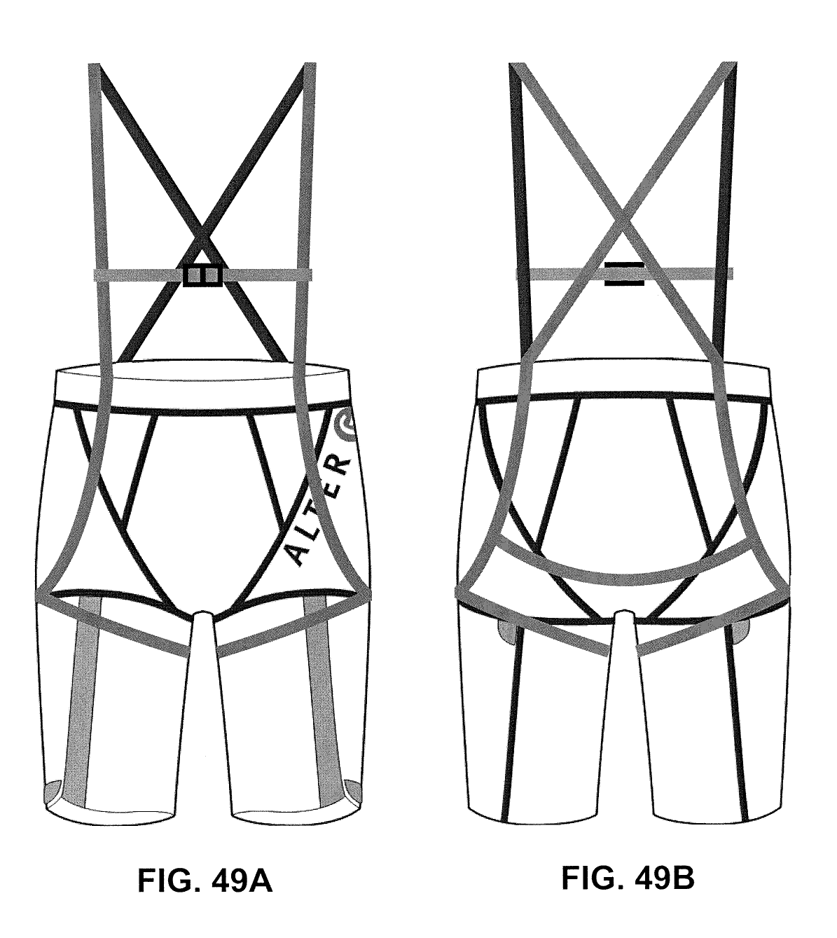

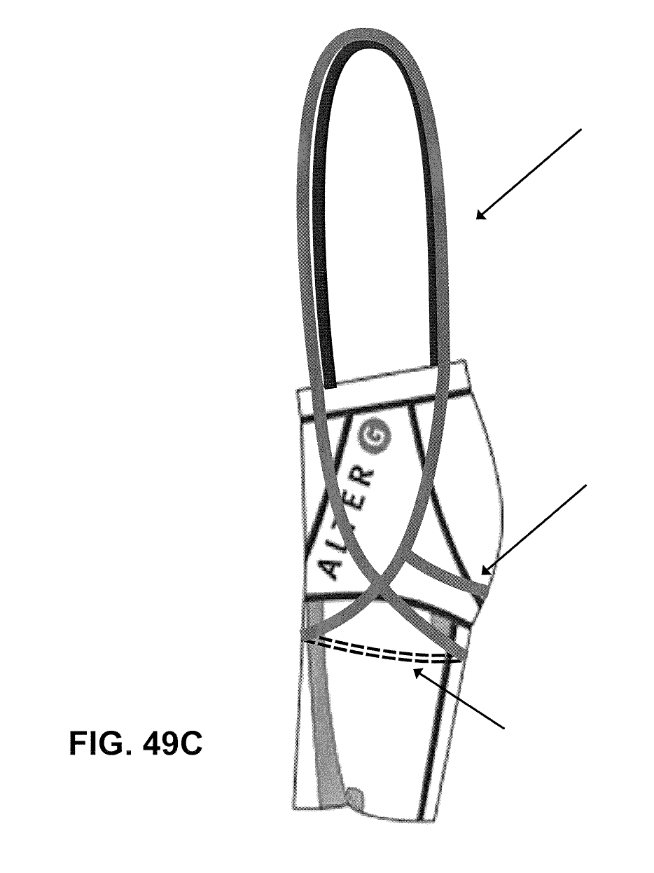

For shorts or garments used without the DAP seal, the reinforcing material may begin and end at the back crossover point thereby providing for a single strip of reinforcing material to be used for both the shoulder straps and garment reinforcement. An exemplary configuration of a non-DAP garment is shown and described below with regard to FIGS. 49A, 49B, and 49C. For garments assembled with a DAP seal and lift assist support system from initial manufacture, the reinforcing material may be inserted between the garment and the support seal thereby also allowing a single reinforcing strap to be used to make both the garment and shoulder strap portions. The reinforcing material attachment technique illustrated in FIGS. 46A, 46B is one technique for attaching reinforcing material to existing garments already having a DAP seal attached.

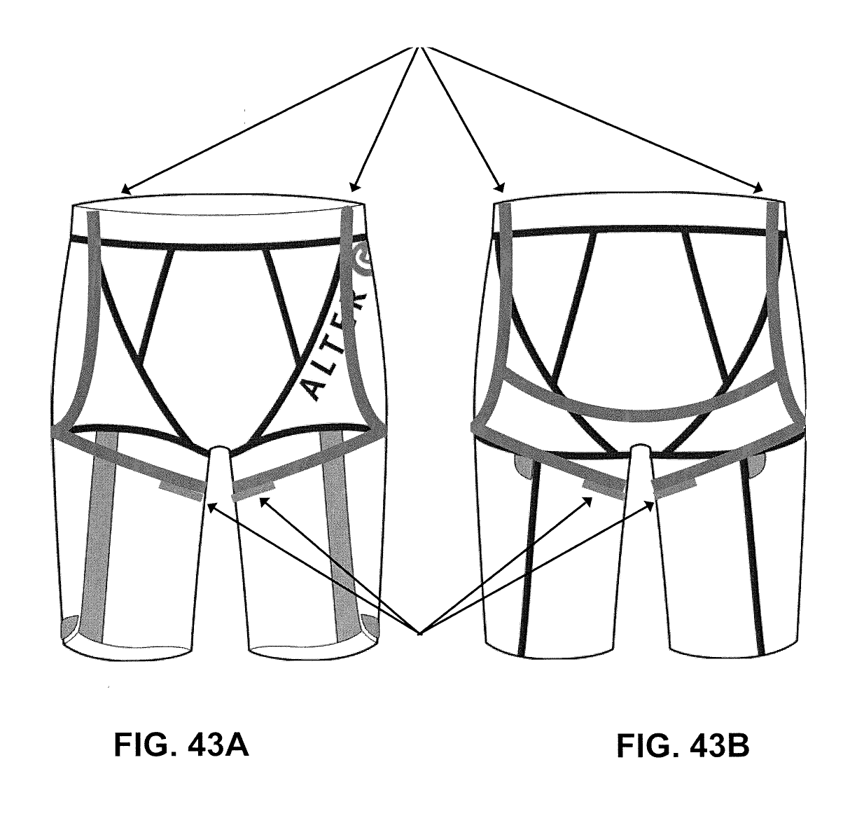

FIGS. 43A and 43B are front and rear views respectively of the DAP shorts of FIG. 42 showing the locations and path of the webbing supports. While the number, location and spacing of reinforcing loops may vary across the shoulder straps and/or garment straps, the embodiment illustrated in FIGS. 43A and 43B indicate where there are no reinforcing loops in the portion of the reinforcing material that extends in the interior aspect of the user's thighs. The path of the reinforcing strap along the front part of the user's thigh, looping towards and along the rear part of the thigh and around and below the buttocks are shown in these views. These paths show the location and trajectory of a non-rigid, looped webbing support system that is attached to the garment. The number and size of support loops applied to the reinforcing material may vary based on location in the shoulder or garment portion.

FIG. 44A is a side, schematic view of an exemplary length of elastic garment body material with an inelastic or low elastic strap material attached to the body material at discrete points. FIG. 44B is an isometric view of an embodiment of the garment with webbing as described in FIG. 44A. FIGS. 44C, 44D and 44E provide force v. elongation curves for different garment and reinforcement materials.

In one embodiment, webbing will be suitably bonded or stitched down to the shorts neoprene in a loose looping pattern following the scale of 1.875 inches of webbing material stitched for every 1.5 inches of neoprene. An exemplary series of webbing loops are shown attached to a portion of a neoprene garment in FIG. 44B. Other looping sizes and spacing are possible in other configurations. While only illustrated as a strip of the same width as the webbing reinforcement, it is to be appreciated that the neoprene is actually in the form factor of a garment and in a location where the reinforcement is desired. Still further, the webbing with may vary from an extra small size to extra-large sizes. Based on user size, and extra small reinforcement webbing may be 1 inch wide and flat webbing since the user weight is relatively low. In a XXXL application (Triple Extra Large user) than the webbing may utilize a two inch wide tubular webbing for increased strength for the relatively higher weight of the user. In still further aspects, a sacrificial stitch may be located at the edge of the portion of the reinforcing loops to show the life of the support system. In one embodiment, the sacrificial stitch would be provided in a contrast color to either of the threads used in the attachment of the webbing system or in contrast to stitches used elsewhere in the garment to ensure the sacrificial stitching is visually apparent. In one embodiment, the sacrificial stitch is located at the edge of one chest loop.

In one aspect, webbing loops continue to be attached to the garment or the strap at the indicated pitch except in the inner thigh area where a single longer continuous loop is left unstitched for user comfort. It is to be appreciated that the pitch of attachment between the webbing and the garment or the webbing and the shoulder straps may vary depending upon location, user type, and garment style. (See explanation with FIG. 44A).

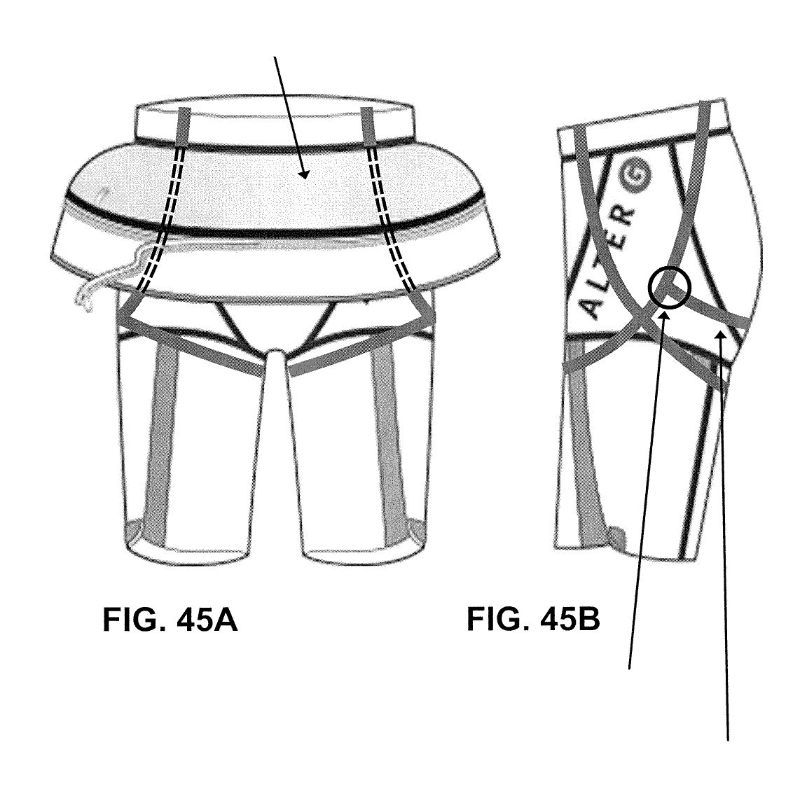

FIGS. 45A and 45B are front and side views respectively of a DAP shorts and seal showing a path of the straps on the garment and in relation to the DAP seal. The dashed lines indicate the passage of the reinforcement strip that is behind the DAP seal. The DAP seal is removed from the view of FIG. 45B for clarity. FIG. 45B shows the location of a box stitch joining the posterior strip to one of the waist to thigh strips from the posterior portion.

FIG. 46A is an exemplary view of the support webbing for the shoulders and shorts support attached using a box stitch that passes through the shoulder support webbing, the garment material, and the shorts webbing. In order to maintain air pressure when a lift support system is applied to a pre-existing pair of DAP shorts, a box stitch is provided to attach the reinforcement material to the DAP garment. As such, the reinforcing material used for the shoulder strap are attached to one side of the garment and the reinforcing strap used for the shorts are attached to the other side (See FIG. 46A). FIG. 46B is an exemplary box stitch as used in FIG. 46A. The size of the box stitch utilized relates to the width of the webbing or reinforcement material used. The box stitch and other stiches may be provided using 7-9 SPI of size 69 or larger polyester or nylon thread. For example, a 1×1 inch box stitch is provided on an 1 inch wide webbing. In another example, a 2×2 inch box stitch is utilized on a 2 inch wide webbing. In one aspect, webbing loops are stitched to the neoprene of the garment across the width of the webbing and with secure backtack at each edge of the webbing. In one embodiment, instead of adjustable shoulder strap buckles, shoulder straps of elastic material are provided to accommodate various sizes of user torso for each size of shorts. In one embodiment, there is provided reinforcement material or webbing as described elsewhere herein used to provide a similar fall safety capability. In one aspect, the reinforcement material or webbing is the same width as the elastic shoulder strap.

FIG. 47 is a rear view of shorts with the reinforcing webbing showing the location of box stitches used to secure the webbing to the shorts elastic material.

FIG. 48A shows a D-ring positioned on a non-reinforced portion of a shoulder strap held in position using a retainer strip. The retainer strip is positioned along the shoulder strap to maintain the D ring in the intent and area of the use. In this illustrative embodiment, the D ring is to be located at the top of the user's shoulders. In this way, the D ring is prevented from falling to a position that impedes the ability to readily attach the user to the overhead support system. The retainer strip is stitched to the shoulder strap at either end as shown in the drawing. FIG. 48B is a side view of a D ring as described and illustrated in FIG. 48A in position on the shoulder strap. The length of the retaining strip allows for easy movement of the D ring within the appropriate location relative to the shoulder strap. Before attaching shoulder straps to the shorts at the suspender attachment point, the D ring is installed on each shoulder strap. The D ring position relative to the strap is restrained to the shoulder location by another strip of webbing or elastic underneath the straight bar the D ring in order to keep it in a usable position the top of the shoulder area. The D ring is selected to be weight specific to the size of the shorts /loading is selected based upon the estimated user weight based on garment size (i.e., XS less load than XXXL).

FIG. 48C shows a D-ring positioned on a reinforced portion of a shoulder strap held in position using a retainer strip. In this illustrative embodiment, the reinforcement loops are provided along the shoulder strap within the same region where the retainer strip is located.

FIGS. 49A, 49B and 49C illustrate, respectively, front, rear and side views of a shorts having a reinforcing straps attached to the garment and including a shoulder strap. In this illustrative embodiment, a non-DAP version of the same shorts is provided to make a simplified fall mitigation system that is easier for user to donn or for a physical therapist to apply to a user. The shorts will follow the same manufacturing processes that were described above except there will be no need for separate shoulder straps webbing and shorts webbing attachment at the waist since there is no DAP seal. As a result, a single reinforcement webbing may be used as described above to form all of the reinforcement needed for both the shorts and the shoulder straps. The ends of the single webbing support may be attached with appropriate stitching at the crossing point at the back of the user. (See FIG. 42).

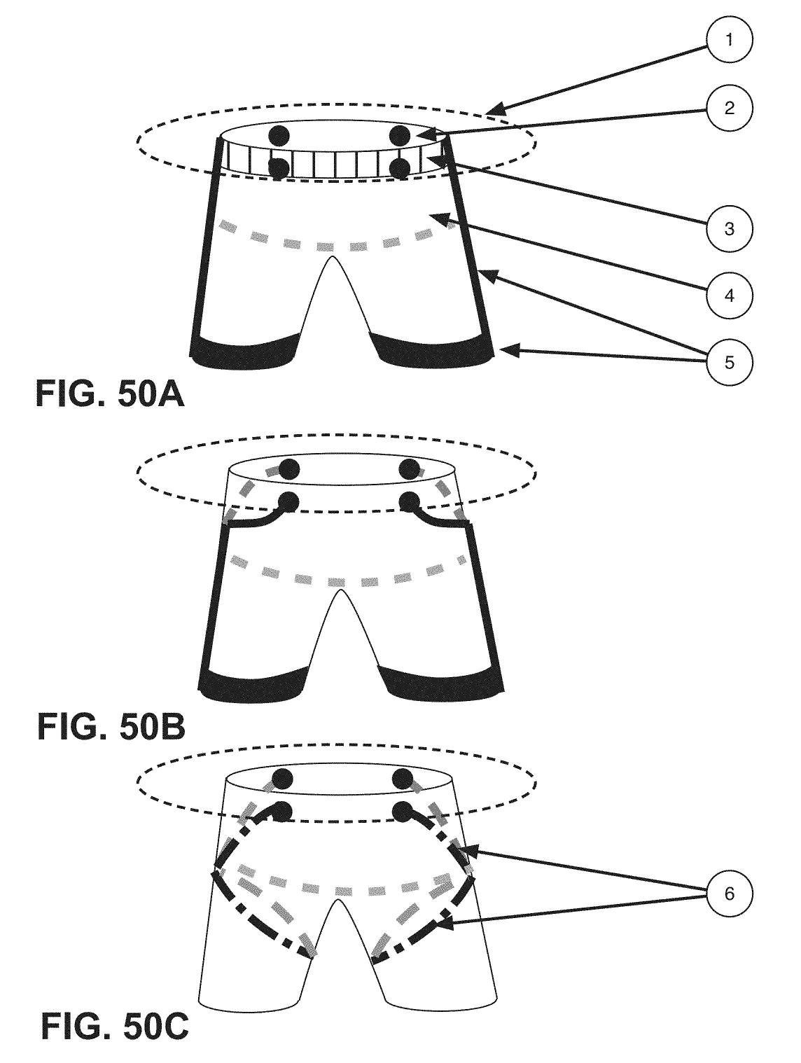

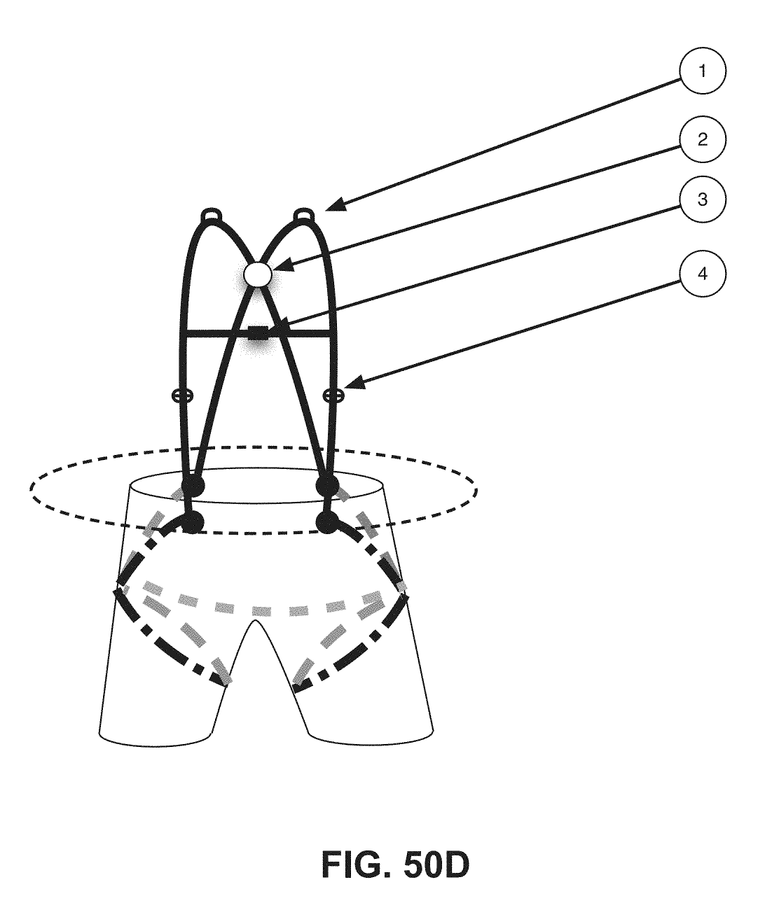

FIG. 50A is a perspective view of a running support short with a DAP seal and indication of hip/waist style support points. FIG. 50B is a perspective view of a running support short with a DAP seal hip support points. FIG. 50C is a perspective view of a pair of shorts with a DAP seal and additional reinforcement for providing fall safety capabilities. FIG. 50D is a perspective view of a pair of running shorts with fall safety reinforcements as illustrated in FIG. 50C and including an embodiment of a shoulder suspension system. Comparison of the location and type of reinforcement and attachment points for the various shorts illustrate the difference between the unweighting support provided by embodiments of FIGS. 50A and 50B versus fall safety reinforcement provided in the embodiments of FIGS. 50C and 50D.

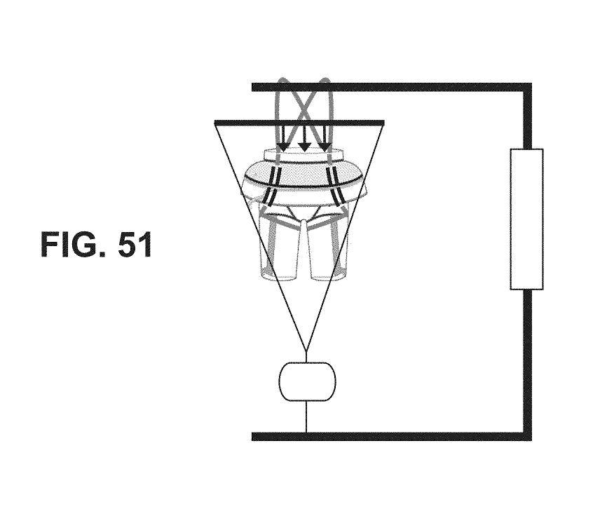

FIG. 51 is a perspective view of an exemplary test fixture utilized to test the strength of garments having reinforcement webbing straps. The test fixture was built using a simulated user based on hydraulic jack and load sensor to provide 1.5× the maximum weight intended for system use. In this test, a maximum user weight of 400 pounds was used therefore leading to a load test of 600 pounds (i.e., 1.5× max load). The garment tested was washed 10 times and inspected for signs of stitch failure. The tested garment passed this test. The garment was then exposed to a 600 pound load for 20 minutes and also passed this test. Thereafter, the garment was exposed to a failure test. The pressure was gradually increased until failure. At a pressure of 1300 pounds the neoprene of the garment failed. An inspection of the failed article revealed that the webbing and all stitches demand intact.

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

What is claimed is:

1. A fall mitigation garment for use with a differential air pressure system, comprising:
an article of clothing having two leg portions configured to provide an airtight fit around legs of a user and a waist portion configured to fit proximate to hips of the user;
a differential air pressure seal coupled to the waist of the garment and including an engagement element used to form a seal with a component of a differential air pressure system;
a support strap attached to the article of clothing extending from the waist portion along and around the user leg portions and to form a pair of suspenders adapted to extend over the user's shoulders; and
an overhead support system adapted to be coupled to the user via the suspenders.

2. The garment of claim 1 further comprising a fitting to couple the suspenders to the overhead support system.

3. The garment of claim 2 wherein the fitting is a D-ring.

4. The garment of claim 2 wherein the fitting comprises a snap shackle.

5. The garment of claim 1 wherein the support strap is a strip of nylon webbing.

6. The garment of claim 1 wherein the support strap is a strip of nylon webbing that is stitched to the garment at a spacing wherein a loop of the support strap is formed between each location where the support strap is stitched to the garment.

7. The garment of claim 1 wherein the support strap is a strip of nylon webbing that is stitched to the garment at a spacing wherein a loop of the support strap is formed at a pre-determined interval along a portion of the garment.

8. The garment of claim 1 wherein a portion of the suspenders is an elastic material further comprising a limited elastic material support strap attached to the suspenders to form one or more loops of the support strap.

9. The garment of claim 7 including a sacrificial stitch positioned to indicate when use of the garment should end.

10. The garment of claim 2 further comprising a restraining strap attached to a portion of the suspenders to maintain the fitting in relation to the overhead support system connection point.

11. The garment of claim 1 further comprising a portion of the garment extending over a portion of the user abdomen or torso.

12. The garment of claim 1 further comprising a reel tensioned adjustment device within a portion of the garment extending over a portion of the user abdomen or torso or in a portion of the garment adjacent a thigh or the buttock.

13. The garment of claim 1 further comprising a pair of attachment mechanisms in the waist portion, the pair of attachment mechanisms configured to attach the garment to a device for unloading a portion of the user's weight.

14. The garment of claim 1 wherein one single reinforcement member is provided to be the reinforcement member within or attached to the article of clothing extending from one of the attachment points and along and around the user leg portions to another of the attachment points and the straps extending from the attachment points to extend over the user's shoulders with a fitting to couple the straps to the overhead device.

15. The garment of claim 1 further comprising a portion of the support strap around the leg portion and along an interior aspect of the thigh has a length of the support strap that is about the same length as the underlying garment material.

16. A fall mitigation garment, comprising:
an article of clothing having two leg portions configured to fit around legs of a user and a waist portion configured to fit proximate to hips of the user;
a pair of attachment points in the waist portion, the pair of attachment points configured to attach the article of clothing to an overhead device for supporting a portion of the user's weight;
a reinforcement member within or attached to the article of clothing extending from one of the attachment points and along and around the user leg portions to another of the attachment points;
straps extending from the attachment points to extend over the user's shoulders with a fitting to couple the straps to the overhead device.

17. The garment of claim 16 wherein the fitting is a welded D-ring.

18. The garment of claim 16 wherein the fitting comprises a snap shackle.

19. The garment of claim 16 wherein the reinforcement member is a strip of nylon webbing.

20. The garment of claim 16 wherein the reinforcement member is a strip of nylon webbing that is stitched to the garment at a spacing wherein a loop of the reinforcement material is formed between each location where the reinforcement material is stitched to the garment.

21. The garment of claim 16 wherein the reinforcement member is stitched to the garment at a spacing wherein a loop of the reinforcement material is formed at a pre-determined interval along a portion of the garment.

22. The garment of claim 16 wherein the straps extending from the attachment points to extend over the user's shoulders include an elastic material and a reinforcement material is attached to the shoulder straps to form one or more loops of reinforcement material.

23. The garment of claim 16 including a sacrificial stitch positioned to indicate when use of the garment should end.

24. The garment of claim 16 further comprising a DAP seal coupled to the waist portion of the garment.

25. The garment of claim 16 further comprising a portion of the garment extending over a portion of the user abdomen or torso.

26. The garment of claim 16 further comprising a reel tensioned adjustment device within a portion of the garment extending over a portion of the user abdomen or torso or in a portion of the garment adjacent a thigh or the buttock.

27. The garment of claim 16 further comprising a pair of attachment mechanisms in the waist portion, the pair of attachment mechanisms configured to attach the garment to a device for unloading a portion of the user's weight.

28. The garment of claim 16 wherein one single reinforcement member is provided to be the reinforcement member within or attached to the article of clothing extending from one of the attachment points and along and around the user leg portions to another of the attachment points and the straps extending from the attachment points to extend over the user's shoulders with a fitting to couple the straps to the overhead device.

29. The garment of claim 16 further comprising a portion of the reinforcement member around the leg portion and along an interior aspect of the thigh has a length of the reinforcement member that is about the same length as the underlying garment material.
